(19) United States
(12) Patent Application Publication
(10) Pub. No.: US 2026/0271903 A1
(43) Pub. Date: Sep. 17, 2026

(54) Fishing Bobber

(71) Applicant: WATHEN TACKLE LLC, Owensville, IN (US)

(72) Inventor: Michael T. Wathen, Owensville, IN (US)

(21) Appl. No.: 19/670,680

(22) Filed: May 7, 2026

Related U.S. Application Data
(63) Continuation-in-part of application No. 19/193,681, filed on Apr. 29, 2025.
Application No. 19/193,681 is a continuation-in-part of application No. 18/542,914, filed on Dec. 18, 2023, now abandoned.

(51) Int. Cl. A01K 93/00

(52) U.S. Cl. CPC A01K 93/00

(57) ABSTRACT

Current embodiments include fishing bobbers with directional buoyancy and strike sensitivity indicators, having a trunk with a top section and a bottom section, which is configured for with a plurality of line eyes for engaging a segment of a fishing line and whose structural features include, but are not limited to, the bottom section being heavier than the lighter and more buoyant top section such that in use the heavier bottom section stays submerged below the surface of the water and at least part of the top section is above the surface of the water and visible to an angler prior to a fish strike, with a geometry of such fishing bobber further characterized as an asymmetric, lobulated body with a center of mass laterally offset from a conceptual axis extending centrally through the top and bottom portions of the trunk, the offset thereby creating a cantilever-like pivot point to enhance the directional buoyancy and strike sensitivity indicators and providing an advantage to the angler compared to conventional bobbers characterized by trunks having a round and symmetric geometry.

### CROSS-REFERENCE TO RELATED APPLICATIONS

This patent application is a continuation-in-part of, and claims a benefit of and priority to, U.S. patent application Ser. No. 19/193,681 with a filing date of Apr. 29, 2025, which is a continuation-in-part of U.S. patent application Ser. No. 18/542,914 with a filing date of Dec. 18, 2023 (now abandoned), the contents and entire disclosures of said applications being fully incorporated herein by reference.

### FIELD OF INVENTION

This disclosure relates generally to fishing tackle and, more particularly, to fishing bobbers configured to provide visual and discernible indication of a fish strike via rotation of such a bobber about one or more axes thereof, and additionally to bobbers capable of indicating the location of a fish relative to the bobber and the direction in which the fish is moving. The bobber also is capable of indicating to an angler positioned above the water surface whether bait is still on the hook below the surface. Additionally, this disclosure relates to bobbers having counter-balanced structures and buoyancy which provide reduced resistance in the fishing line beneath the water surface and a rotational visual and discernible indication to the angler upon a fish strike. In turn, present embodiments provide a bobber that is highly sensitive in that when a fish strikes, or lightly bites at bait on the hook, it will cause the bobber to axially rotate about a horizontal axis thereof relative to the water surface move in a cantilever-like way that is perceptible to the angler.

### BACKGROUND

Floating fishing bobbers have been long used, serving the dual functions of suspending a bait laden hook a desired distance below the surface of the water, and of providing visual and discernible indication of the presence of a fish taking the bait. Large fish may take both hook and bait into their mouths and tug to completely sink the bobber, which provides an unquestionable notice of the fish's presence. Smaller fish may only nibble at the bait on the hook, causing only a minor, perhaps unnoticed response of the bobber. In the latter event, especially if the bobber is distant from the angler, the presence of the fish may go undetected. Fishing is touted as, and is in reality among, the most relaxing of avocations. As such, fishing can be accompanied by drowsiness and the lack of alert perceptivity needed to notice small bobber disturbances. Small disturbances may even be seen when attributed to gentle waves and breezes rather than to the fish.

There is a need for a floating fish bobber having a shape and structure that indicates the presence of a fish biting at the hook with enhanced sensitivity, i.e., that will provide the angler a visual and discernible indication of slight, and even most subtle, bites from a fish, also referred to as a fish strike.

### SUMMARY OF EMBODIMENTS

An object of present embodiments is to provide a bobber that provides to an angler a visual and discernible indication that a fish strike has occurred and of a general location of the fish and the direction in which it is swimming with the bait and hook in its mouth. Another object of present embodiments is to provide a fishing bobber (sometimes referred to as “bobber” for brevity) that exhibits a reduced, or a more gradual, resistance in the line given that, when a fish senses resistance from the bait or line, it will often drop the bait and move on after perceiving a false presentation.

Present embodiments meet these objects and others by providing a bobber with directional buoyancy indicator that may include a trunk, a limb and first means for engaging a segment of the fishing line. When a fish strikes the hook at the end of the line and continues swimming, the limb rotates in the direction in which the fish is swimming providing a visual and discernible indication to the angler.

In some embodiments, there is provided a bobber with directional buoyancy indicator for attachment to a fishing line comprising a trunk, a limb and first means for engaging a segment of the fishing line. The trunk may include a weighted first end and a buoyant second end such that when in use, the weighted first end is below the surface of the water and the buoyant second end is above the surface of the water substantially above the first end. The limb has a first end affixed to the trunk proximate to the second end of the trunk and extending radially outwardly therefrom. The first means for engaging a segment of the fishing line is positioned proximate to a second free (or terminal) end of the limb.

The trunk of the bobber may be hollow and may include a plurality of openings in an outer surface thereof between the first weighted end and the second buoyant end. The plurality of openings may be a plurality of vertical slots. The trunk may be a cylinder having a first sealed cap at the first weighted end and a second sealed cap at the second buoyant end.

A sealed air pocket may be provided at the second buoyant end of the trunk for providing buoyancy to the bobber. The trunk may be formed from a plastic material and the plastic material at the first weighted end has a density greater than the density of the first end of the trunk.

In some embodiments in which a limb is present, the limb may extend radially outwardly from the trunk in a plane that is substantially perpendicular to a central axis of the trunk. A second means for engaging a second segment of fishing line proximate to the buoyant second end of the trunk may be provided. In this configuration, the first line segment engaging means engages a segment of fishing line that is closer to a hook at a terminal end of the fishing line.

Alternatively, the limb may extend radially outwardly from the trunk at a downward angle toward the first weighted end of the trunk. A second means for engaging a second segment of fishing line proximate to the buoyant second end of the trunk may be provided. In this configuration, the first line segment engaging means engages a segment of fishing line that is closer to a hook at a terminal end of the fishing line. The first fishing line segment engaging means and the second fishing line segment engaging means may each comprise a line eye to which the respective segments of fishing line are secured.

According to a further alternative embodiment, the limb extends radially outwardly from the trunk at an upward angle away from the first weighted end of the trunk. The first fishing line segment engaging means may comprise a line eye to which the segment of fishing line is secured. Still further, present embodiments may include a sleeve that is removably attached to an outer surface of the limb proximate to the second end thereof, the sleeve being configured to fix the line to the bobber.

According to a further alternative embodiment, the first fishing line segment engaging means comprises an opening in the limb through which the line passes and the second fishing line segment engaging means comprises a line eye through which the line passes. Yet a further embodiment of the invention provides a weighted magnet located at the weighted first end of the trunk. The magnet provides both weight and means for removably attaching additional weights.

In some embodiments, the inventive fishing bobber comprises an asymmetric, lobulated body having a weighted lower portion that is laterally offset from the vertical axis of the body. The bobber includes a plurality of line eyes and internal channels that allow the fishing line to pass through the body. In use, an offset center of mass creates a cantilever-like pivot point of rotation, causing the bobber to rotate in the direction of a fish strike rather than merely submerging, thereby providing hypersensitive visual and discernible indication.

In some embodiments, the bobber includes a recess or indentation on the outer surface of the top portion of the trunk positioned between line eyes. This indentation is sized and configured to receive and seat a bobber stop element, allowing the stop to nest within the profile of the bobber body. Optionally, the bobber includes a substantially flat top surface having a recess or indentation for receiving a fishing line stop element.

These and other objects, features and advantages of the present embodiments will become apparent from a review of the following drawings and descriptions of multiple embodiments and alternatives of the inventive bobber.

### BRIEF DESCRIPTION OF THE FIGURES

The drawings, schematics, figures, and descriptions herein are to be understood as illustrative of structures, features and aspects of the present embodiments and do not limit the scope of the embodiments. Where the figures provide or suggest dimensional information, the scope of the application is not limited to the precise arrangements, scales, or dimensions as shown in the drawings.

FIG. 1 is a perspective view of a fishing bobber (sometimes referred to as simply, “bobber” for brevity) with directional buoyancy indicator according to multiple embodiments and alternatives.

FIG. 2 is a side sectional view of the fishing bobber with directional buoyancy indicator shown in FIG. 1.

FIG. 3 is a side sectional view of the fishing bobber with directional buoyancy indicator according to multiple embodiments and alternatives.

FIG. 4 is a side sectional view of the fishing bobber with directional buoyancy indicator according to multiple embodiments and alternatives.

FIG. 5A is a top view of the fishing bobber with directional buoyancy indicator shown in FIG. 1 prior to a fish strike.

FIG. 5B is a top view of the fishing bobber with directional buoyancy indicator shown in FIG. 1 and FIG. 5A after a fish has struck the hook and moved to the left.

FIG. 6A is a perspective view of a fishing bobber with directional buoyancy indicator according to multiple embodiments and alternatives.

FIG. 6B is a perspective view of the fishing bobber with directional buoyancy indicator shown in FIG. 6A shown here in a partially assembled configuration.

FIG. 7 is a perspective view of a fishing bobber with directional buoyancy indicator according to multiple embodiments and alternatives.

FIG. 8 is a perspective view of a fishing bobber with directional buoyancy indicator according to multiple embodiments and alternatives.

FIG. 9 is a perspective view of a fishing bobber with directional buoyancy indicator and bait indicator according to multiple embodiments and alternatives.

FIG. 10 is a cutaway perspective view of the bobber shown in FIG. 9.

FIG. 11 is a side elevation view of the bobber shown in FIG. 9 shown floating on the water with no bait on the hook.

FIG. 12 is a side elevation view of the bobber shown in FIG. 9 shown floating on the water with bait on the hook.

FIG. 13 is a perspective cutaway view of a fishing bobber with directional buoyancy indicator and bait indicator according to multiple embodiments and alternatives.

FIG. 14 is a cutaway side elevation view of the bobber shown in FIG. 13.

FIG. 15 is a side elevation view of the bobber shown in FIG. 13 shown floating on the water with no bait on the hook.

FIG. 16 is a side elevation view of the bobber shown in FIG. 13 shown floating on the water with bait on the hook.

FIG. 17 is a side elevation view of a fishing bobber with directional buoyancy indicator and bait indicator according to multiple embodiments and alternatives, shown floating on the water with no bait on the hook.

FIG. 18 is a side elevation view of the bobber shown in FIG. 17 shown floating on the water with bait on the hook.

FIG. 19 is a bottom view of the bobber shown in FIG. 17.

FIG. 20A is a top perspective view of a fishing bobber with directional buoyancy indicator and bait indicator according to multiple embodiments and alternatives.

FIG. 20 B is a side sectional view of the bobber shown in FIG. 20A.

FIG. 21 is a schematic view of a kind of conventional fishing bobber used in fishing.

FIG. 22 is a perspective view of a fishing bobber according to multiple embodiments and alternatives.

FIG. 23 is a top-side plan view of the bobber of FIG. 22, according to multiple embodiments and alternatives.

FIG. 24 is a bottom-side plan view of the bobber of FIG. 22, according to multiple embodiments and alternatives.

FIG. 25 is a proximal-side elevation view of the bobber of FIG. 22, according to multiple embodiments and alternatives.

FIG. 26 is a distal-side elevation view of the bobber of FIG. 22, according to multiple embodiments and alternatives.

FIG. 27 is a left-side elevation view of the bobber of FIG. 22, according to multiple embodiments and alternatives.

FIG. 28 is a right-side elevation view of the bobber of FIG. 22, according to multiple embodiments and alternatives.

FIG. 29 is a perspective view of the bobber of FIG. 22 partially submerged relative to a surface of water, attached to a fishing line, and having an attached hook with bait attached to the fishing line, according to an exemplary use case of the fishing bobber.

FIG. 30 provides perspective views of three axes of a fishing bobber according to multiple embodiments and alternatives.

FIG. 31 illustrates a conceptual horizontal plane shown through a fishing bobber according to multiple embodiments and alternatives to describe its asymmetric geometry.

FIG. 32 and FIG. 33 provide perspective views of a fishing bobber according to multiple embodiments and alternatives to describe and illustrate additional rotational movements.

FIG. 34 is a perspective view of the bobber of FIG. 22 showing its asymmetric shape from a mostly proximal side-facing perspective view.

FIG. 35 is a perspective view of the bobber of FIG. 22 shown in a partially assembled configuration with a fishing line stop element positioned on an attached fishing line between the second line eye and the third line eye, according to multiple embodiments and alternatives.

FIG. 36A is a view similar to FIG. 25 and showing broken line A-A to indicate the plane upon which a sectional view is taken as illustrated in FIG. 36B.

FIG. 36B is a cross-sectional view of a fishing bobber taken along line A-A in FIG. 36A, according to multiple embodiments and alternatives.

FIG. 36C is the same cross-section view as FIG. 36B with gradient arrows to indicate the distribution of weight in the trunk.

FIG. 37 is a perspective view of the bobber of FIG. 34, further depicting one or more internal channels configured as tubes, according to multiple embodiments and alternatives.

FIG. 38 is a perspective view of a fishing bobber according to multiple embodiments and alternatives, including an indentation positioned between the second line eye and third line eye in which a stop element attached to a fishing line may be seated.

FIG. 39 is a top-side plan view of the bobber of FIG. 38.

FIG. 40-FIG. 42 are cross-sectional views of the bobber of FIG. 38 taken along line B-B in FIG. 39, with the bobber positioned at different degrees of rotation.

FIG. 43 is a perspective view of a fishing bobber according to multiple embodiments and alternatives, wherein the top portion is at least partially flat and contains within the flat area an indentation on the outer surface of the top portion of the trunk between the second line eye and third line eye in which a line stop element attached to a fishing line may be seated.

FIG. 44 is a perspective view from a mostly proximal side-facing perspective view of the bobber of FIG. 43 showing the asymmetric shape of the bobber and the indentation in the outer surface within the flat area of the top portion, according to multiple embodiments and alternatives.

FIG. 45A is a perspective view of a bobber according to multiple embodiments and alternatives.

FIG. 45B is cross-sectional view of a fishing bobber taken along line B-B in FIG. 45A, according to multiple embodiments and alternatives.

References in the figures to axes and planes are conceptual and not intended to indicate added physical structure.

### MULTIPLE EMBODIMENTS AND ALTERNATIVES

To promote an understanding of the principles of the embodiments described herein, their structure, and their deployment in use, reference is now made to the drawings and descriptions as set forth herein. The following is meant to be illustrative, and no limitation to the scope of the subject matter herein is intended by the following descriptions. Rather, it will be understand that the scope of embodiments includes reasonable alterations and modifications to the described and illustrated embodiments, to include further applications of the principles of the described embodiments as would normally occur to one skilled in the relevant art.

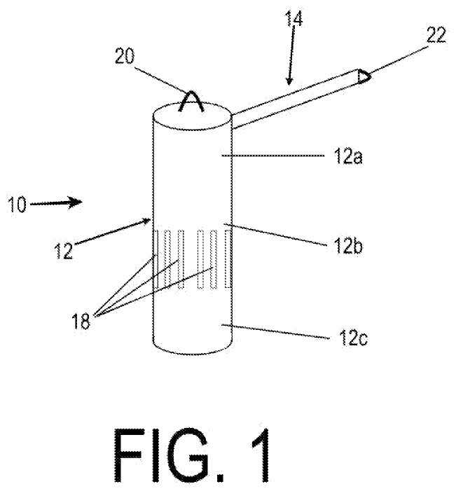

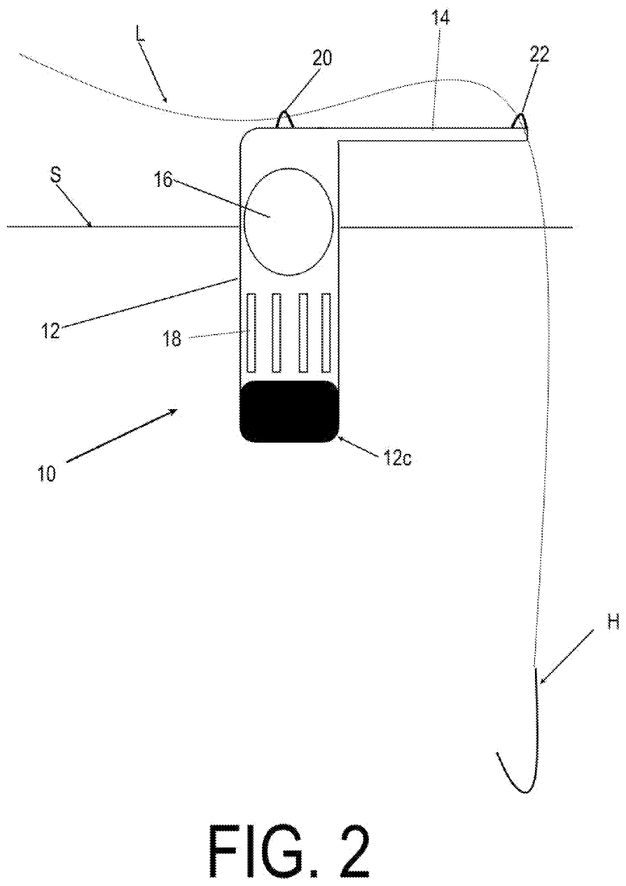

As best shown in FIG. 1, one embodiment of the invention comprises a fishing bobber 10 with directional buoyancy indicator. The bobber 10 includes a trunk 12, a portion of which floats above the surface of the water, and a limb 14 extending radially outwardly from the trunk 12 at or near a top section 12a of the trunk 12 above the surface of the water. The trunk 12 may by cylindrically shaped. According to an embodiment of the invention, the bottom section 12c of the trunk 12 is weighted in order to ensure that the central axis of the trunk 12 is perpendicular to the surface of the water. The top section 12a of the trunk 12 may include an air pocket 16 (as shown in FIG. 2) to keep the upper portion of the bobber floating above the surface of the water. The bottom section 12c of the trunk 12 can be weighted by forming it from or otherwise incorporating a plastic or other material having a density greater than the density of the materials in the middle section 12b and upper section 12a of the trunk 12. The middle section 12b of the bobber trunk 12 may also include one or more openings 18 therein to allow water to pass through the bobber 10 thereby adding weight to the bottom section 12c of the trunk, and thus adding stability to the bobber 10.

A first line eye 20 may be located at or near the top surface of the trunk 12 and a second line eye 22 may be located at or near the free (or terminal) end of the limb 14. As used herein, the term “line eye” refers to an opening, aperture, or port located on an outer surface of the trunk, and configured to allow a fishing line to pass. As shown in FIG. 2, the bobber 10 is secured to the line L, by passing the line through the first line eye 20, then through the second line eye 22 before it is connected to a hook H at the free (or terminal) end of the line L. The line L is secured to the bobber 10 at each of the line eyes 20, 22 and the depth of the hook H is determined by the fisherman by the length of line between the hook H and the second line eye 22. When a fish engages the hook H (i.e., a fish strike occurs), the line L will be pulled and the free end of the limb 14 will rotate in the direction that the fish is taking the hook H.

The limb 14 of the bobber 10 shown in FIG. 2 extends radially outwardly from the trunk 12 and is oriented substantially perpendicular to the longitudinal axis of the trunk 12 and substantially parallel to the surface S of the water. Preferably, the free end of the limb 14 is about 1.5 inches above the surface S when in use.

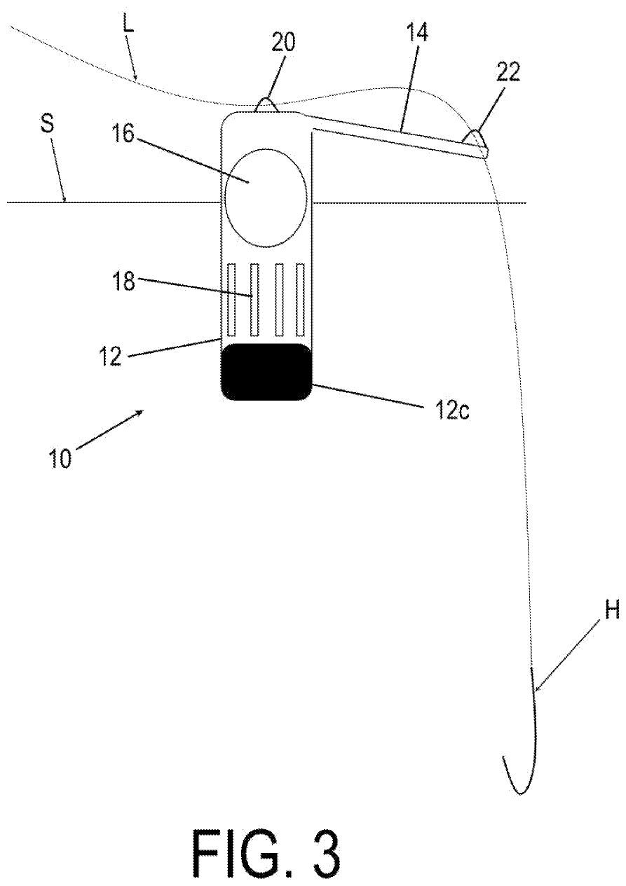

According to a first alternative embodiment as shown in FIG. 3, the limb 14 is angled downwardly toward the surface S of the water such that the free end of the limb 14 is closer to the surface S than the end that is affixed to the top of the trunk 12. In this embodiment, the free end of the limb 14 is also about 1.5 inches above the surface S when in use, while the end affixed to the trunk 12 is about 2.5 inches above the surface S.

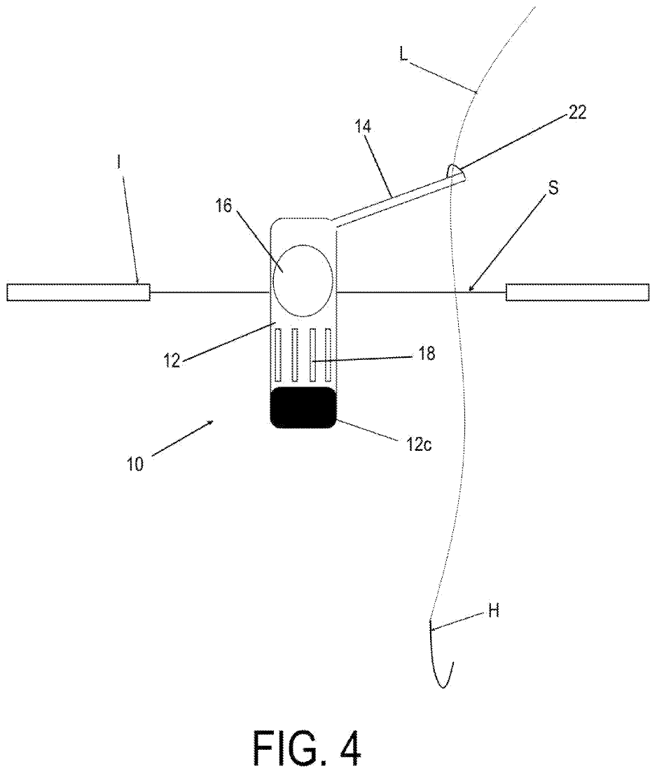

A second alternative embodiment, as shown in FIG. 4, is useful for ice fishing where a hole is cut in the frozen surface I of a body of water leaving a small opening water surface S. Because the opening is small and the thickness of the ice may vary, the limb 14 is angled upwardly away from the surface S of the water such that the free end of the limb 14 is further from the surface S than the end that is affixed to the top of the trunk 12. In this embodiment, the free end of the limb 14 is also about 3 inches above the surface S when in use, while the end affixed to the trunk 12 is about 1.5 inches above the surface S. Also, when this embodiment is deployed, the line L need only pass through and be secured to the line eye 22 at the free end of the limb 14.

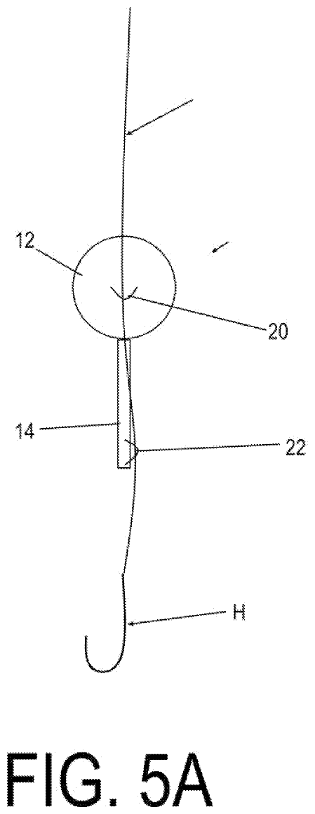

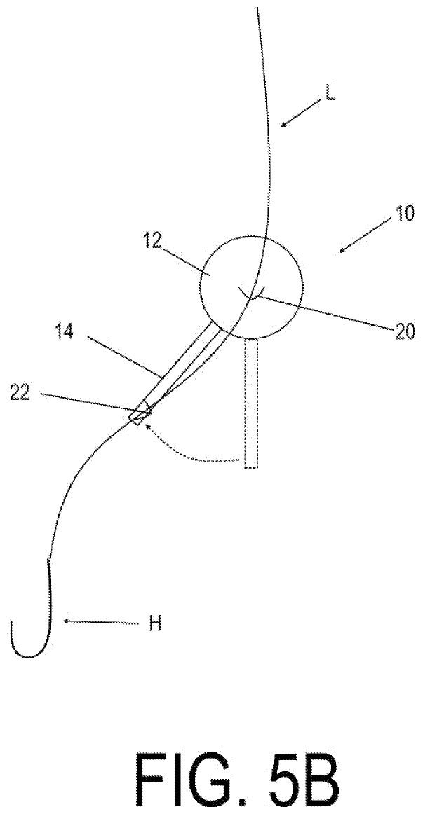

FIG. 5A and FIG. 5B depict the bobber 10 in operation. As shown in FIG. 5A, when there is not a fish on the hook H, the limb 14 will essentially point in a neutral direction. However, as depicted in FIG. 5B, when a fish strikes the hook H and pulls it in a horizontal direction, the limb 14 will rotate in that direction indicating to the angler that there is a fish on the hook and what general direction that fish is swimming.

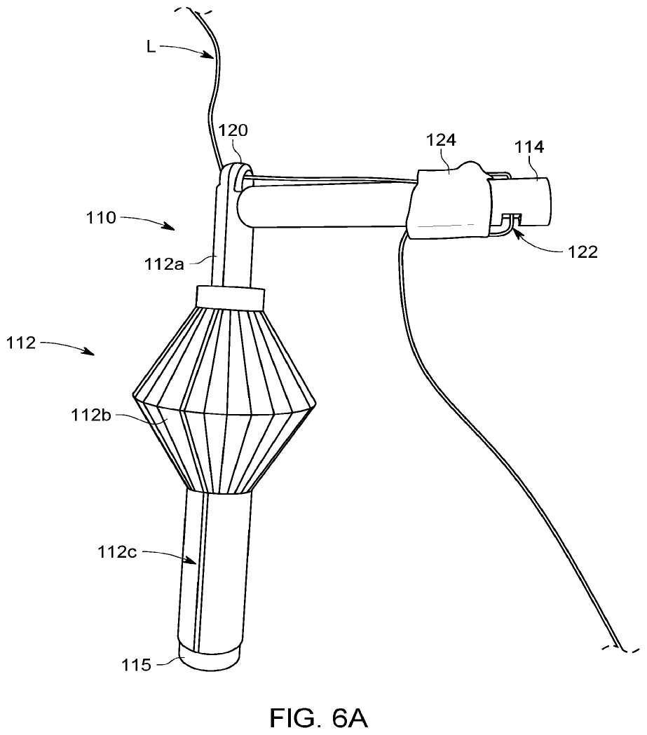

FIG. 6A and FIG. 6B show a bobber 110 according to a further preferred embodiment. The bobber 110 according to this embodiment is like the embodiments shown in FIG. 1-FIG. 5B wherein like reference numerals indicate like components. As in the prior embodiments, the bobber 110 includes a trunk 112, a portion of which floats above the surface of the water, and a limb 114 extending radially outwardly from the trunk 112 at or near a top section 112a of the trunk 112 above the surface of the water. The trunk 112 may include a diamond-shaped float 112b that is designed to float at the surface of the water when in use. The bottom section 112c of the trunk 112 may include a magnet embedded at or near the bottom thereof. Weight(s) can be added to the bobber 110 by adding additional magnets or metal discs 115 to the bottom of the trunk 112c. The magnet at the base of the trunk 112c releasably holds the magnet/weight 115 in place, thereby adding weight if desired. Additional magnets/weights 115 can be stacked on the first magnet/weight 115 to add additional weight if desired. The diamond shaped float section 112b of the trunk 112 may include an air pocket (not shown) to keep the upper portion of the bobber 110 floating above the surface of the water.

A first line eye 120 may be located at or near the top surface of the trunk 112 and an opening 122 extending through the limb 114 near the free end thereof is also provided. As shown in FIG. 6B, the bobber 110 is secured to the line L, by passing the line L through the first line eye 120, then through the opening 122 before it is connected to a hook (not shown) at the free end of the line L. Between the line eye 120 and the opening 122, the line L passes through a sleeve 124. As shown in FIG. 6A, once the length of line below the bobber 110 is selected by the fisherman, the sleeve 124 is then slid onto the end of the limb 114 thereby securing the line to the bobber 110.

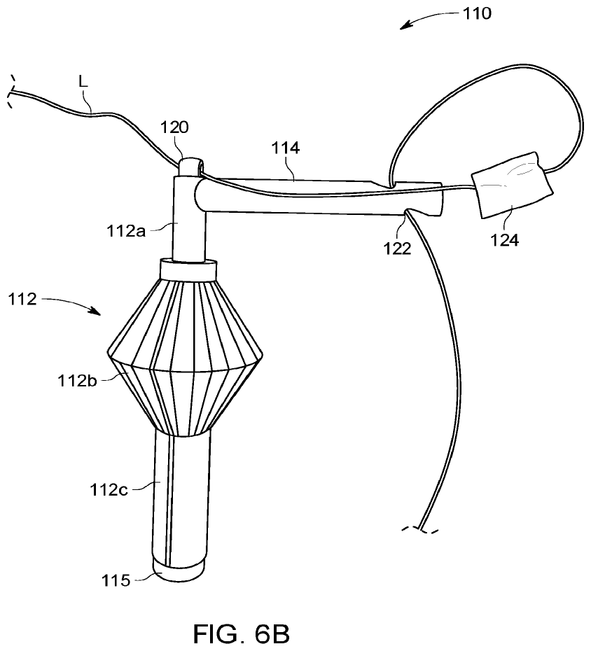

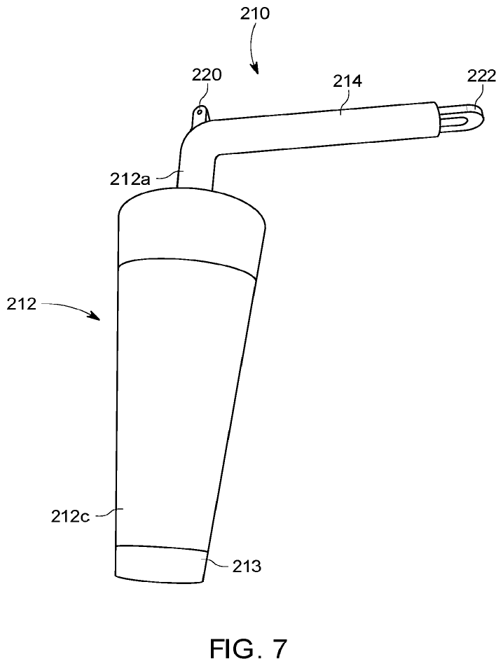

FIG. 7 shows a bobber 210 according to a further preferred embodiment. The bobber 210 according to this embodiment is like the embodiments shown in FIG. 1-FIG. 6B wherein like reference numerals indicate like components. As in the prior embodiments, the bobber 210 includes a trunk 212, a portion of which floats above the surface of the water, and a limb 214 extending radially outwardly from the trunk 212 at or near a top section 212a of the trunk 212 above the surface of the water. The trunk 212 is generally a tapered cylinder that has a relatively large diameter at the top end 212a, and a smaller diameter at the bottom end 212c. The bottom end 212c of the trunk 212 may include a magnet 213 embedded at or near the bottom thereof. Weight(s) can be added to the bobber 210 by adding additional magnets or metal discs (not shown) to the bottom of the trunk 212c. The magnet at the base of the trunk 212c releasably holds the magnet/weight in place, thereby adding weight if desired.

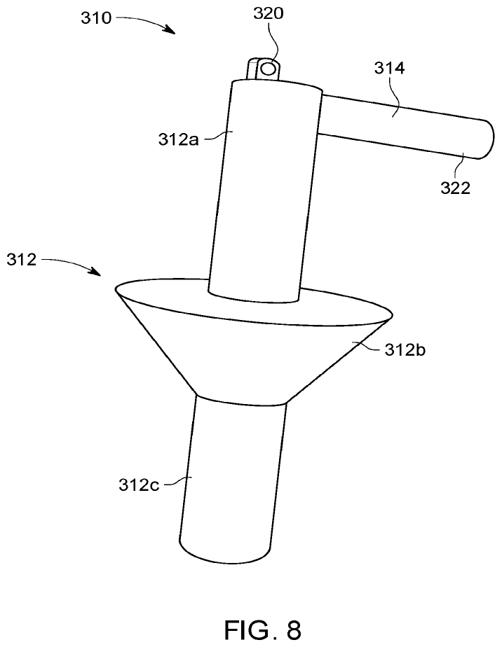

FIG. 8 shows a bobber 310 according to a further preferred embodiment. The bobber 310 according to this embodiment is like the embodiments shown in FIG. 1-FIG. 7 wherein like reference numerals indicate like components. As in the prior embodiments, the bobber 310 includes a trunk 312, a portion of which floats above the surface of the water, and a limb 314 extending radially outwardly from the trunk 312 at or near a top section 312a of the trunk 312 above the surface of the water. The trunk 312 may include a half diamond-shaped float 312b that is designed to float at the surface of the water when in use. The lower section of the float resembles that of the diamond shaped float shown in FIG. 6A and FIG. 6B, but the upper portion is absent leaving a substantially flat top surface. The top section 312a and/or the half diamond-shaped float 312b of the trunk 312 may include an air pocket (not shown) to keep the upper portion of the bobber 310 floating above the surface of the water.

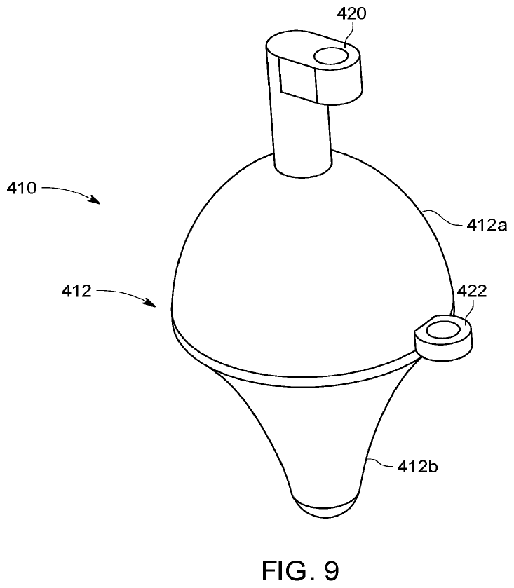

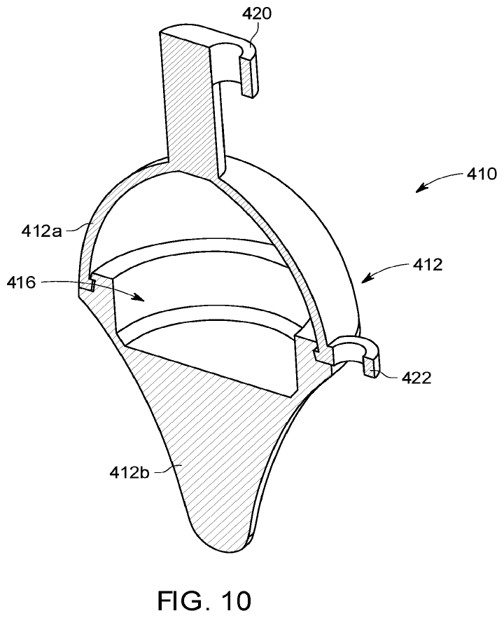

FIG. 9-FIG. 12 show a bobber 410 according to additional alternative embodiments. The bobber 410 according to this embodiment not only has a directional indicator like the previous embodiments, it provides a visual and discernible indication to the angler above the surface of whether there is still bait on the hook H. As in the prior embodiments, the bobber 410 includes a trunk 412, a top portion 412a of which floats above the surface of the water, W and a lower weighted portion 412b that is designed to sit below the surface of the water when in use. The top section 412a of the trunk 412 may include an air pocket 416 to keep the upper portion of the bobber floating above the surface of the water W. The top section 412a and bottom section 412b of the trunk 412 can be molded from plastic and designed to snap together to form the entire trunk 412 having the air pocket 416 in the upper section 412a as shown in FIG. 10.

A first line eye 420 may be located at or near the top of the trunk top section 412a and a second line eye 422 may be located at or near the bottom of the upper trunk section 412a along the outer periphery thereof. As shown in FIG. 11, the bobber 410 is secured to the line L, by passing the line L through the first line eye 420, then through the second line eye 422 before it is connected to a hook H at the free end of the line L. The line L is secured to the bobber 410 at each of the line eyes 420, 422 and the depth of the hook H below the water's surface is determined by the fisherman by the length of line between the hook H and the second line eye 422.

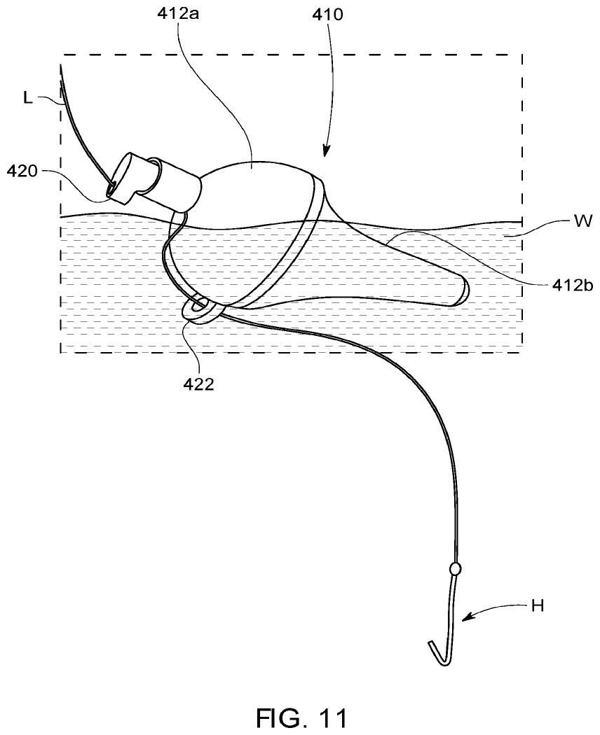

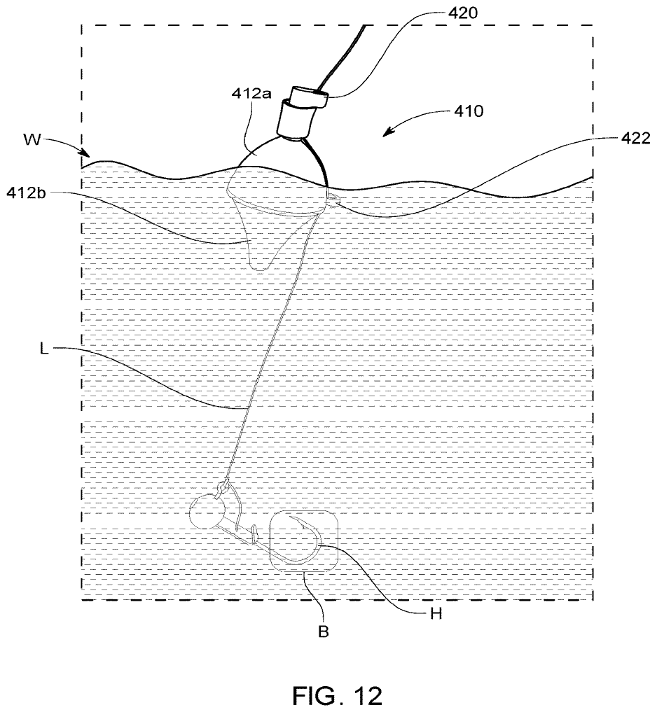

As shown in FIG. 11, when there is no bait on the hook H, the air pocket 416 in the upper section 412a of the trunk 412 and the weighted bottom section 412b cause the bobber 410 to lay almost on its side, indicating that there is no bait on the hook H and/or an insufficient amount of weight (e.g., split shot weight) attached to the line L between the second line eye 422 and the hook H. When there is bait B on the hook H, as shown in FIG. 12, the weight of the bait B pulls down on the line L causing a cantilevered action at the trunk 412 at between the first line eye 420 and second line eye 422. The weight of the bait B pulling down on the line L thus causes the bobber 410 to sit is a more upright position as shown in FIG. 12, indicating to the angler above the surface W that there is bait on the hook H below the surface W.

In accordance with FIG. 9-FIG. 12, when a fish engages the hook H and swims away in a given direction, the point where the line L engages the second line eye 422 will be pulled in that direction causing the trunk 412 to rotate in that direction relative to the first line eye 420 which is located substantially at the center of the trunk 412. This rotation indicates to the angler that a fish is on the line and also indicates the direction that the fish is swimming. Contrasting and/or other colors and/or patterns can be added to the upper section 412a and/or bottom section 412b of the trunk 412 to provide further visual assistance to the angler in making this determination.

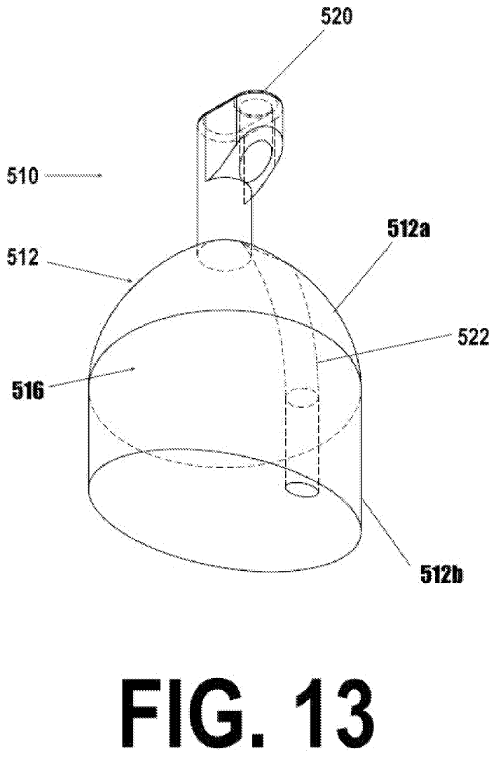

FIG. 13-FIG. 16 show a bobber 510 according to additional alternative embodiments. The bobber 510 according to this embodiment also has both a directional indicator and a bait present indicator. The bobber 510 according to this embodiment includes a trunk 512, a top portion 512a of which floats above the surface of the water W and a lower weighted portion 512b that is designed to sit below the surface of the water W when in use. The top section 512a of the trunk 512 may include an air pocket 516 (as best shown in FIG. 13) to keep the upper portion of the bobber floating above the surface of the water W. The bottom section 512b of the trunk 512 may have a sloped bottom 530 which alters the balance of the bobber 510 putting more weight on one side thereof at the bottom, which creates the cantilevered action necessary to perform the bait present indicator function.

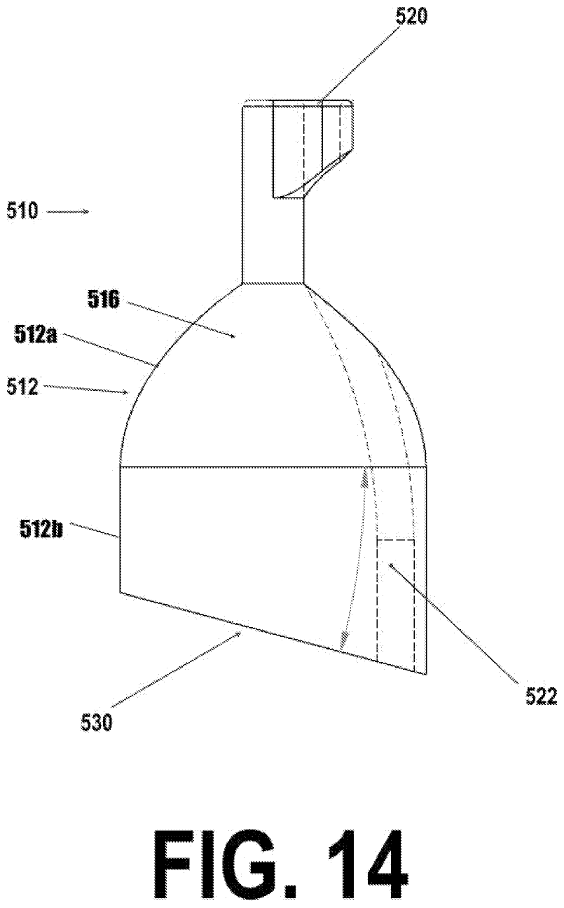

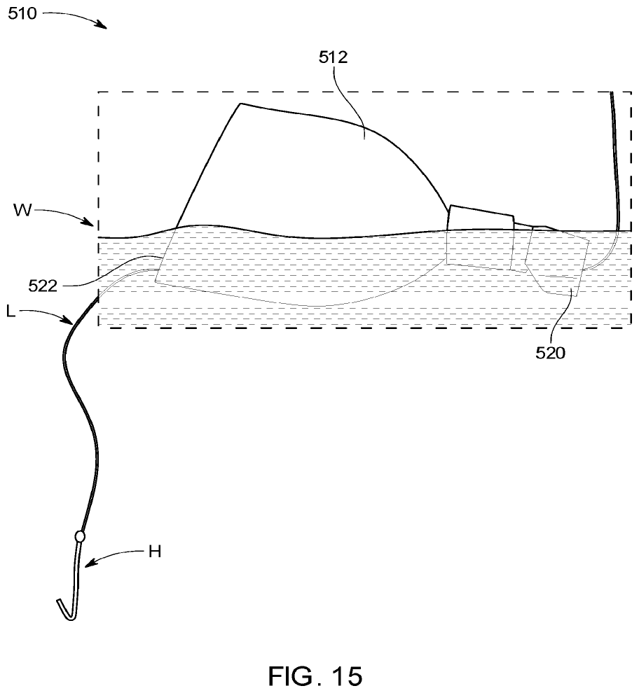

A first line eye 520 may be located at or near the top of the trunk top section 512a. Instead of a second line eye, the bobber 510 according to this embodiment includes a channel 522 passing through the interior portion of the trunk 512. As best shown in FIG. 13 and FIG. 14, the channel 522 begins in the upper section 512a and ends at the lower section of the slope 530 at or near the periphery of the bottom section 512b. As shown in FIG. 15, the bobber 510 is secured to the line L, by passing the line L through the first line eye 520, then through the channel 522 before it is connected to a hook H at the free end of the line L. The line L is secured to the bobber 510 at the first line eye 520 and the depth of the hook H below the surface W is determined by the fisherman by the length of line between the hook H and the point where the line exits the channel 522.

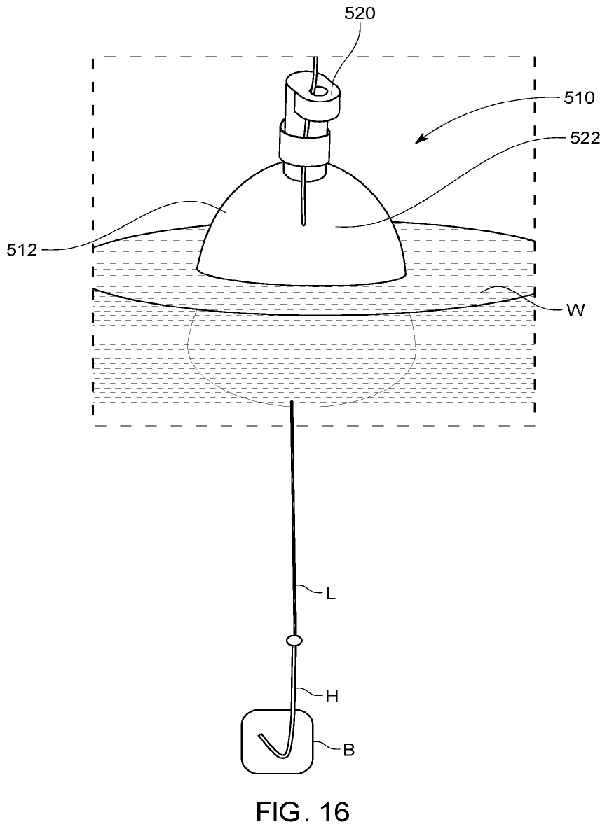

As shown in FIG. 15, when there is no bait on the hook H and/or an insufficient amount of weight (e.g., slip shot weight) attached to the line L between the channel 522 and hook H, the air pocket 516 in the upper section 512a of the trunk 512 and the slanted/side-weighted bottom section 512b cause the bobber 510 to lay almost on its side, indicating that there is no bait on the hook H and/or insufficient weight attached to the line L between the channel 522 and hook H. When there is bait B on the hook H and/or sufficient weight attached to line L between channel 522 and hook H (collectively or individually, for purposes of this specification, the “attached weight”), as shown in FIG. 16, such attached weight pulls down on the line L causing a cantilevered action at the trunk 512 at between the first line eye 520 and channel 522. The attached weight pulling down on the line L thus causes the bobber 510 to sit in a more upright position as shown in FIG. 16, indicating to the angler above the surface W that there is a sufficient amount of attached weight on the hook H and/or the line L between channel 522 and hook H below the surface W.

In accordance with FIG. 13-FIG. 16, when a fish engages the hook H and swims away in a given direction, the point where the line L engages the bottom of the channel 522 will be pulled in that direction causing the trunk 512 to rotate in that direction relative to the first line eye 520 which is located substantially at the center of the trunk 512. This rotation indicates to the angler that a fish is on the line L and also indicates the direction that the fish is swimming. Contrasting and/or other colors and/or patterns can be added to the upper section 512a and/or bottom section 512b of the trunk 512 to provide further visual assistance to the angler in making this determination.

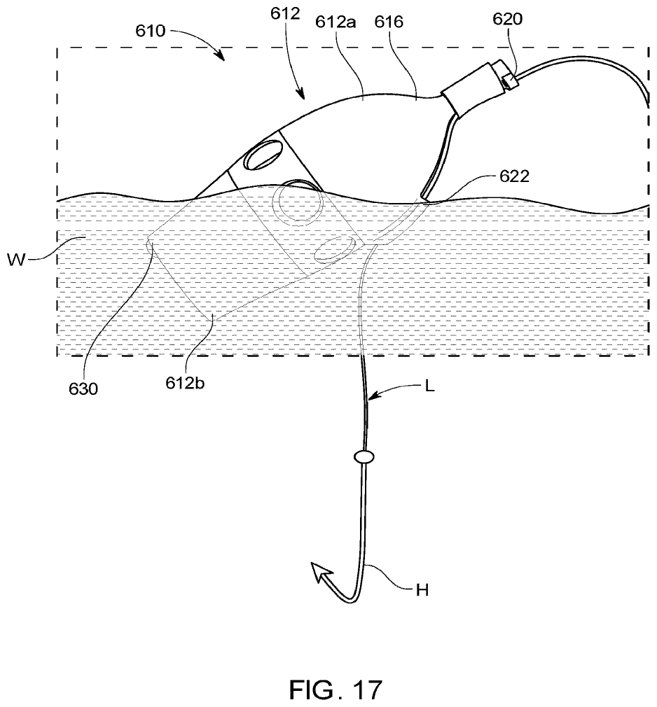

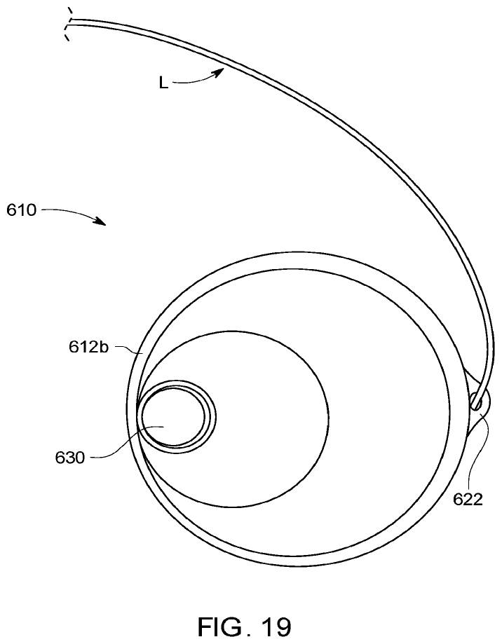

FIG. 17-FIG. 19 show a bobber 610 according to additional alternative embodiments. The bobber 610 according to this embodiment also has both a directional indicator and a bait present indicator. The bobber 610 according to this embodiment includes a trunk 612, a top portion 612a which floats above the surface of the water, W, and a lower weighted portion 612b that is designed to sit below the surface of the water when in use. As best shown in FIG. 19, the bottom portion 612b is weighted by placing a weight, such as a lead weight 630 at or near to lower edge of the bottom section 612b at the periphery thereof. Alternatively, the weighted region in the lower section 612b can be formed by providing more, or higher density, plastic in the area where more weight is desired to create the cantilever effect for attached weight indication.

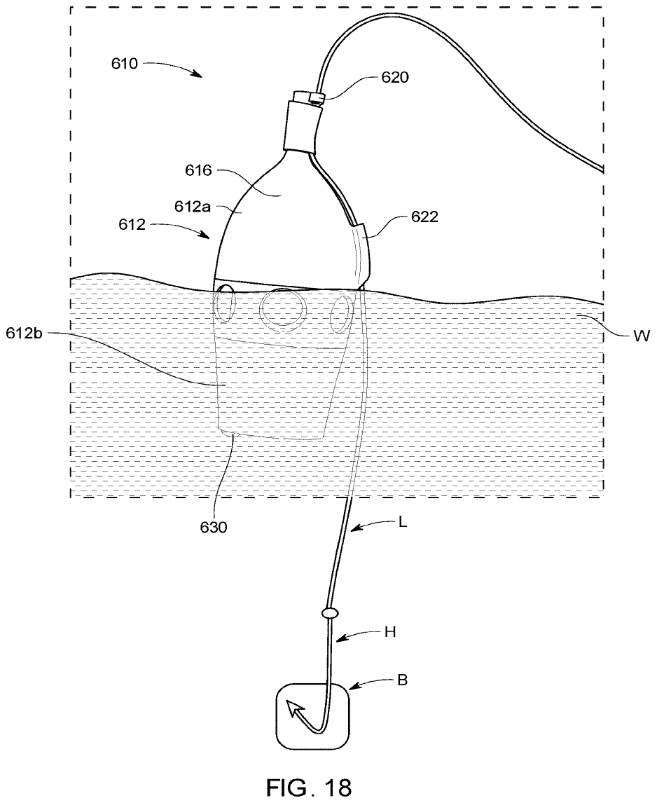

A first line eye 620 may be located at or near the top of the trunk top section 612a. The bobber 610 according to this embodiment includes a second line eye, which may take the form of an external elongated channel 622 along an exterior portion of the trunk 612. As shown in FIG. 17 and FIG. 18, the bobber 610 is secured to the line L, by passing the line L through the first line eye 620, then through the line eye/channel 622 before it is connected to a hook H at the free end of the line L. The line L is secured to the bobber 610 at the first line eye 620 and the depth of the hook H below the surface of the water W is determined by the fisherman by the length of line between the hook H and the point where the line exits the second line eye/channel 622.

As shown in FIG. 17, when there is an insufficient amount of attached weight, the air pocket 616 in the upper section 612a of the trunk 612 and the offset weight 630 in the bottom section 612b cause the bobber 610 to sit on the surface of the water W at an angle, indicating that there is an insufficient amount of attached weight. When there is sufficient attached weight, as shown in FIG. 18, the attached weight B pulls down on the line L causing a cantilevered action at the trunk 612 between the first line eye 620 and the second line eye/channel 622. The attached weight pulling down on the line L thus causes the bobber 610 to sit in a more upright position as shown in FIG. 18, indicating to the angler above the surface W that there is sufficient attached weight.

In accordance with FIG. 17-FIG. 19, when a fish engages the hook H and swims away in a given direction, the point where the line L engages the bottom of the second line eye/channel 622 will be pulled in that direction causing the trunk 612 to rotate in that direction relative to the first line eye 620 which is located substantially at the center of the trunk 612. This rotation indicates to the angler that a fish is on the line and also indicates the direction that the fish is swimming. Contrasting and/or other colors and/or patterns can be added to the upper section 612a of the trunk 612 to provide further visual assistance to the angler in making this determination.

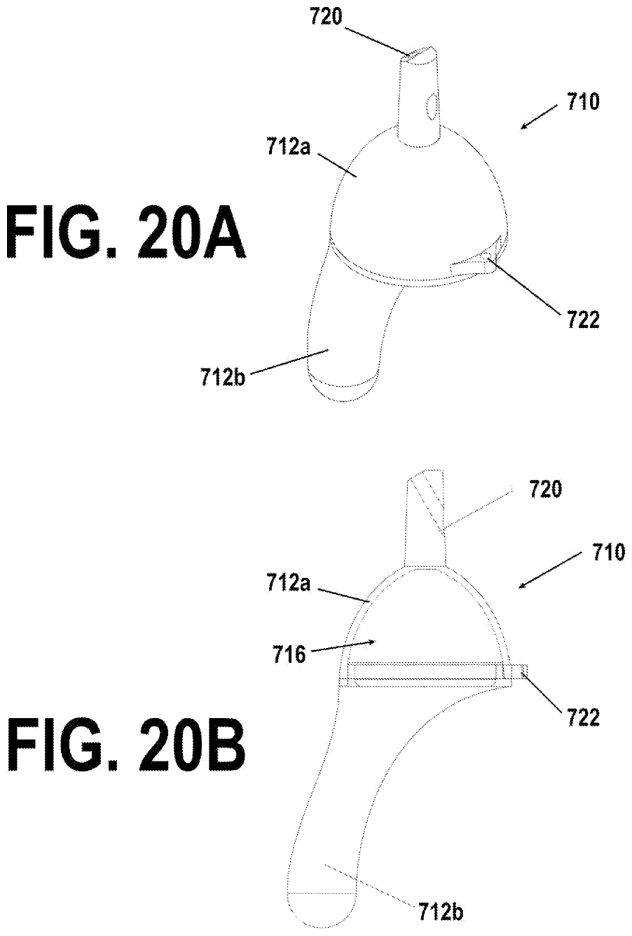

FIG. 20A and FIG. 20B show a bobber 710 according to a further preferred embodiment having a directional indicator and a visual indicator to the angler above the surface of whether there is still bait (weight) on the hook H. As in the prior embodiments, the bobber 710 includes a trunk 712, a top portion 712a of which floats above the surface of the water and a lower weighted portion 712b that is designed to sit below the surface of the water when in use. The top section 712a of the trunk 712 may include an air pocket 716 to keep the upper portion of the bobber floating above the surface of the water W. The top section 712a and bottom section 712b of the trunk 712 can be molded from plastic and designed to snap together to form the entire trunk 712 having the air pocket 716 in the upper section 712a as shown in FIG. 20B. The bottom section 712b of the trunk is formed from solid plastic with the weighted portion thereof set off to one side from the center point of the trunk 712 to make the bobber counteract the weight associated with bait on the hook causing the bobber 710 to sit upright when there is weight/bait on the hook or to lie on its side when there is no weight/bait on the hook.

A first line attachment point or channel 720 may be located at or near the top of the trunk top section 712a and a second line eye 722 may be located at or near the bottom of the upper trunk section 712a along the outer periphery thereof. The bobber 710 is secured to the line by passing the line through the channel 720, then through the second line eye 722 before it is connected to a hook at the free end of the line. The line is secured to the bobber 710 near the channel 720 by a rubber sleeve that surrounds the line and post through which the channel 720 passes.

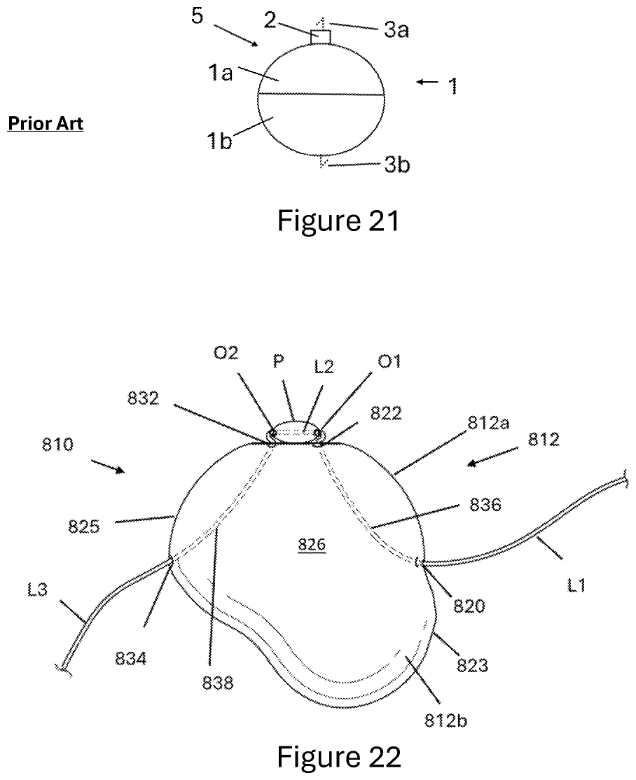

Now with reference to FIG. 22-FIG. 45 provided herein, consider FIG. 21, offering a schematic view of a kind of conventional fishing bobber 5 used in fishing. A trunk 1 comprises a top half 1a and a lower half 1b, which are symmetric or substantially symmetric hemispherical portions forming the trunk 1.

As used herein, the term “asymmetric” refers to a lack of mirror-image symmetry or equivalent geometric proportionality across a defining plane or axis. By way of example, as perhaps best illustrated in the side profile and/or perspective views of FIGS. 22, 29, 32, and 36B, the bobber 810 is characterized by an asymmetric geometric profile when viewed from a direction substantially orthogonal to the roll axis Z-Z as described herein.

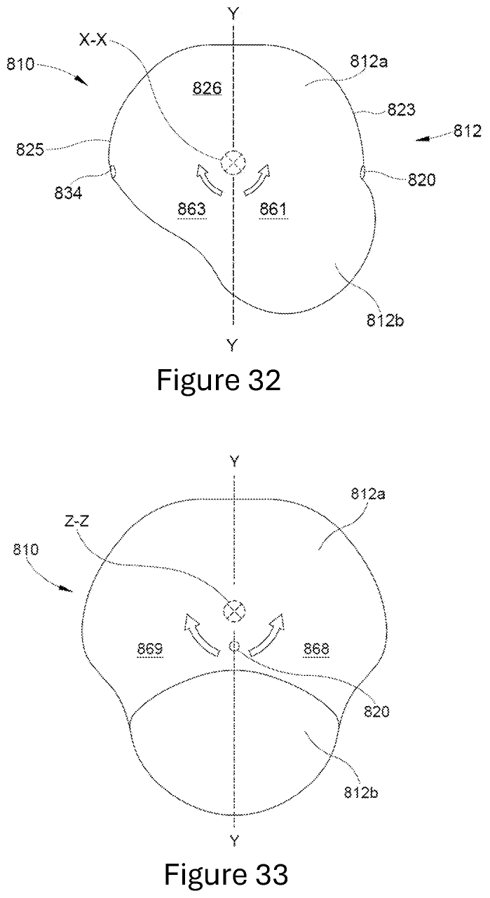

Viewed in relation, but not limited, to the above referenced side profile and perspective views, asymmetry is illustrated by the differing exterior contours and volumetric distributions of the trunk 812 with respect to one or more defining planes and/or axes. For example, the top portion 812a of the trunk 812 comprises a broad, bulbous curvature extending toward the proximal and distal sides (823, 825) of the bobber 810, whereas the lower weighted portion 812b of the trunk 812 defines a distinct, downwardly protruding lobe that is offset relative to the vertical yaw axis Y-Y toward the proximal side 823. This structural arrangement results in an asymmetric and generally lobulated form of the outer surface of the bobber 810 when viewed from either the first lateral (or right) side (826) or second lateral (or left) side (828). Accordingly, when the bobber 810 is used in an aquatic environment with the fishing bobber aligned with a first axis, the trunk 812 exhibits an unequal weight distribution laterally and vertically, when viewed from a perspective facing either the right side 826 as seen in FIG. 22 and FIG. 32, for example, or the left side 828 of the bobber 810. Additionally, the structural asymmetry is further illustrated in the non-uniform transition of the lower portion 812b between the proximal side 823 and the distal side 825 of the trunk 812 of the bobber 810. As seen in FIG. 32, the top portion 812a exhibits a greater radius of curvature than the lower weighted portion 812b, creating a multi-lobed appearance of the trunk 812 and bobber 810.

A plunger 2 is integrated within the top half 1a of the trunk 1 which, when pushed down into the top half 1a or otherwise manipulated, allows access to first and second line engaging hooks 3a, 3b. These are positioned relative to the top and lower halves 1a, 1b and shown in broken lines (as shown in FIG. 21, above the plunger 2, and below the bottom half 1b of the trunk 1) to indicate optional movements comprising extension out of and retraction back into the trunk 1 by manipulating the plunger 2, as is known in the art. When the engaging hooks 3a, 3b are in an extended position, an angler can pass the fishing line through the two hooks 3a, 3b and then release the plunger 2 thereby causing the hooks 3a, 3b to retrack back into the trunk 1 and secure such conventional bobber 5 to the fishing line.

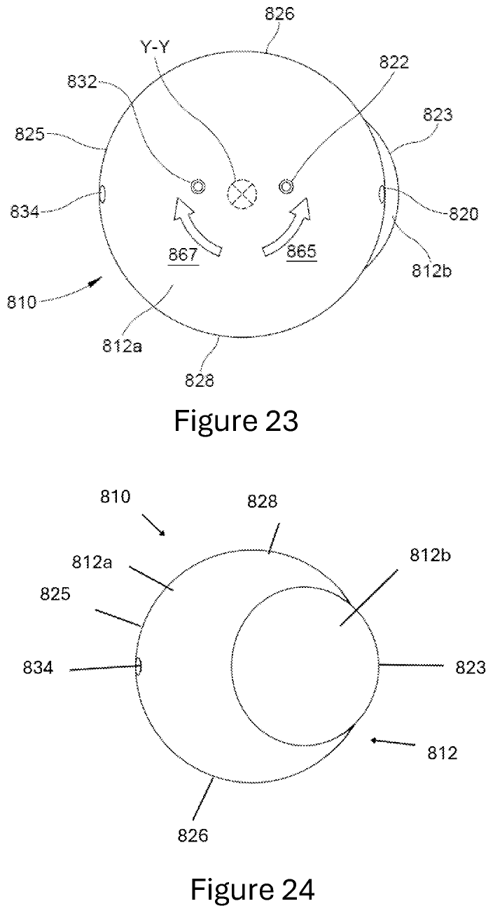

By comparison, with respect to present embodiments, and as seen for example in FIG. 23-FIG. 26 and FIG. 34, the inventive bobber 810 defines an outer surface with a first lateral side (or right side) 826 and a second lateral side (or left side) 828, each extending between the proximal and distal sides (823, 825) of the trunk 812 of the bobber 810.

More specifically, FIG. 22 illustrates a bobber 810 according to multiple embodiments and alternatives. The bobber 810 comprises a buoyant body or trunk 812 having an asymmetric outer surface with a curvilinear geometry. In some embodiments, the structure of a top portion 812a of the trunk 812 is formed as a primary bulbous portion that transitions on the proximal and distal sides (823, 825) of the trunk 812 of the bobber 810—via smooth, continuous, asymmetric compound curvatures—into a lower weighted bulbous portion (or bottom portion) 812b. The top portion 812a and bottom portion 812b are configured to be attached to a fishing line, L.

As illustrated in the accompanying figures, one or more stop elements, P (variably referred to as a “bobber stop,” “stopper,” “string tie,” “ribbon,” or “line limiter”) are moveably disposed along the fishing line L. The stop element, P, is configured to provide a selective mechanical interference fit with the fishing line, L, effectively defining a fixed point of reference that dictates the maximum extension of the line L through the bobber 810 and extending from the distal side 825 of the trunk 812 such that when the fishing line, L, is pulled taut, the stop element, P, is retained against an outer surface of the trunk 812. In some nonlimiting examples in accordance with multiple embodiments and alternatives of the bobber disclosed herein, one or more stop elements P may be positioned on the line L and retained against an outer surface of the trunk 812 (a) abutting the proximal side 823 of the bobber 810 at or near the first line eye 820, and/or (b) abutting the top portion 812a of the trunk 812, for example between second and third line eyes (822, 832). For clarity, the fishing line, L, and stop element(s), P, are not part of the trunk 812 or bobber 810.

With further reference to FIG. 22, the fishing line, L, is advanced through the bobber 810 and stop element, P, as follows. The line, L, enters the interior of the bobber 810 by an angler or other user inserting it into the first line eye 820, is advanced through first internal channel 836, and exits the bobber 810 through second line eye 822. The line, L, then is advanced into a first opening, O1, of the stop element, P, then proceeds through the interior of the stop element P and subsequently exits the stop element P through a second opening thereof, O2. The line, L, then reenters the interior of the bobber 810 by insertion into the third line eye 832, is advanced through second internal channel 838, and exits the bobber 810 through the fourth line eye, 834. For additional reference, FIG. 22 shows the line, L, in three segments, L1-L3. L1 is the part of the line, L, that first enters and exits the bobber; this part may be closer to a position of the angler upon casting the line. L2 is the part of the line, L, between line eyes 822 and 832, respectively. L3 is the part of the line, L, that re-enters and finally exits the bobber, and to which the hook and bait would be attached, as shown in other figures. The designation of these segments, L1-L3, is intended only to add clarity to the description of an exemplary use of the inventive bobber. These designations form no part of the claimed embodiments. It will be appreciated that in use, parts of L2 may be located within the stop element, P—as shown in broken lines in FIG. 22 and as further illustrated in FIG. 35—with other parts of L2 located external to the stop element P and bobber 810, between line eye 822 and O1, on one side, and between O2 and line eye 832 on the other side.

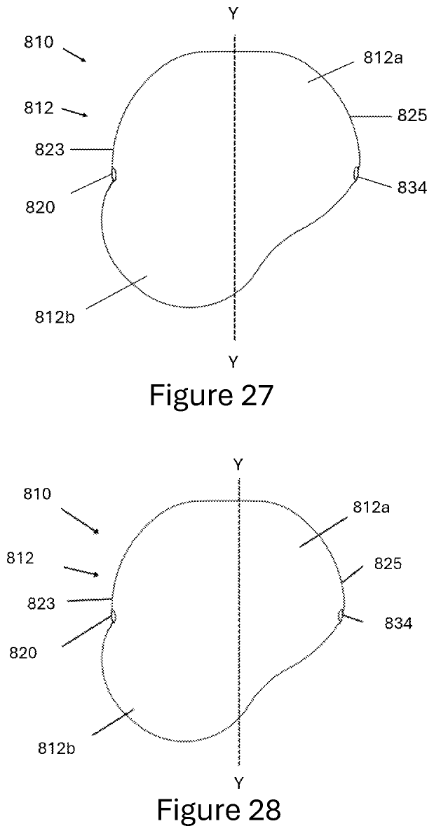

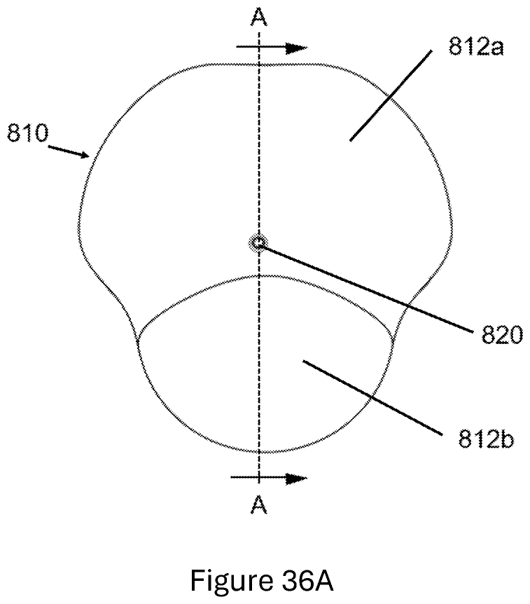

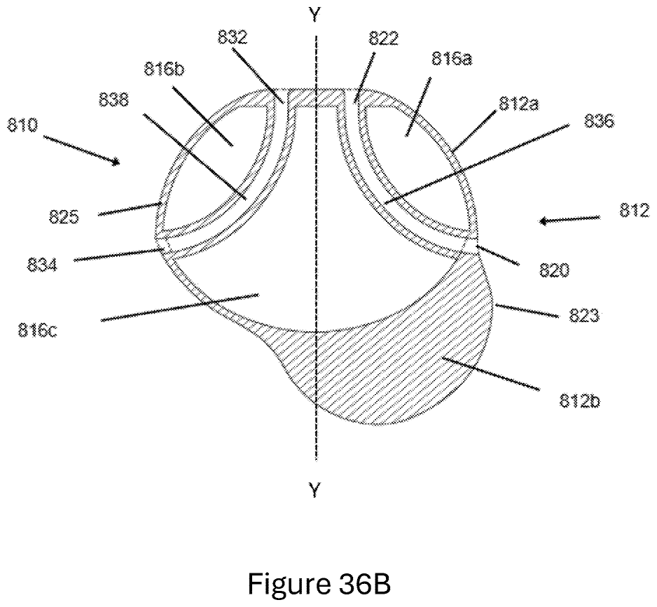

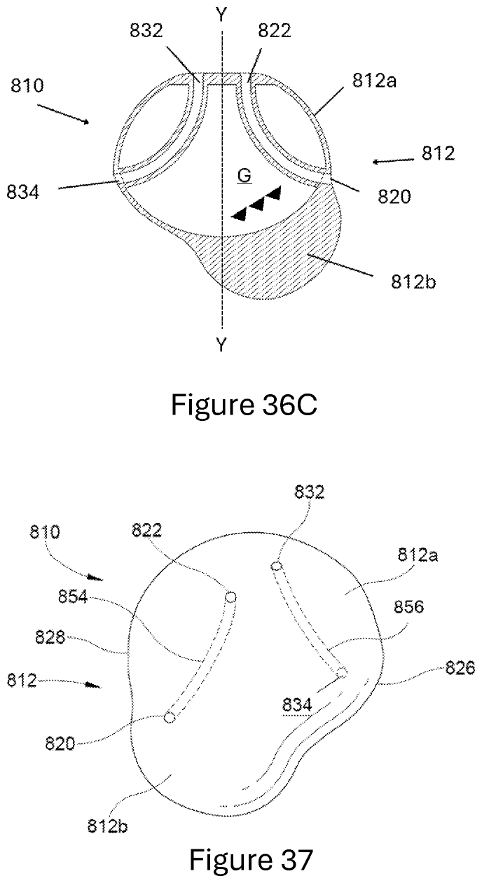

As shown in the side elevation views of FIGS. 26 and 27 (together with reference to FIGS. 23, 28, 32, 36B and 36C), the lower weighted portion 812b of the trunk 812 is laterally offset from the vertical yaw axis Y-Y toward the proximal side 823. This shifts a center of mass (not shown) of the lower weighted portion 812b so it is laterally offset from a vertical yaw axis, Y-Y, toward the proximal side 823 and is not aligned with a center of mass (also not shown) of the top portion 812a. Optionally, in some embodiments, the bobber 810 further comprises one or more air pockets 816, as shown in FIG. 36B, to keep the top portion 812a of the bobber 810 floating above the surface S of the water when in use. The one or more air pockets 816 (shown in FIG. 36B as 816a-816c) may be hollow cavities (0% infill) formed during a 3D printing or other manufacturing process. Though not limiting on the scope of the disclosure herein, the lower weighted portion 812b may be formed from solid plastic (i.e., 100% infill), as shown in FIG. 36B. Alternatively, the lower weighted portion 812b may be formed from, include and/or otherwise incorporate partially infilled plastic (i.e., less than 100% infill) and/or other non-buoyant material to ensure the lower weighted portion 812b sits below the surface S of the water when in use and provides a counterbalancing of weight across the bobber 810 among the proximal and distal sides (823, 825).

With respect to embodiments as illustrated in the figures, it will be noted the trunk is not divided into symmetric or substantially symmetric geometric hemispheres. For example, FIG. 23 and FIG. 24 illustrate the bobber 810 in plan views, in which neither the bobber 810 nor the trunk 812 conform to a standard geometric primitive, such as a simple sphere, cylinder, or object formed from symmetric hemispherical portions. Rather, as seen in these and other figures, the outer surface of the bobber 810 and trunk 812 defines a generally lobulated form. Accordingly, the geometry of the lower portion 812b—partially seen in FIG. 23 and as more completely shown in FIG. 24—as compared with the top portion 812a is one aspect of a non-standard, asymmetric relationship between the bottom portion 812b and the top portion 812a. Thus, it is one thing for a bobber to have a simple geometric outer shape, such as in the case of conventional bobbers (e.g., prior art bobber 5, as shown in FIG. 21) comprising symmetric or substantially symmetric hemispherical portions, as generally illustrated as top half 1a and lower half 1b in FIG. 21 (prior art). By contrast, accompanying figures (as perhaps best shown in FIGS. 22, 27, 28, 29, 32, 34, 35, 36B, 36C, and 37) illustrate that—from a side elevational view of the bobber 810, wherefrom the viewing angle is oriented at, approximately, or generally perpendicular to either (a) the first lateral (or right side) 826, or (b) the second lateral (or left side) 828, of the bobber 810 (in other words, when the viewing direction of the bobber 810 is substantially or generally orthogonal to the roll axis Z-Z, as described below—the outer surface of the bobber 810 defines an asymmetric, generally lobulated form.

FIG. 23 shows top and bottom portions 812a, 812b of the trunk 812 of the bobber 810, along with four line eyes in the outer surface of the bobber 810, which are labeled first, second, third, and fourth line eyes 820, 822, 832, 834, respectively. While four line eyes are shown, the bobber 810 generally may have only two line eyes, or it may have more than two. The line eyes may be formed integrally within the trunk 812, for example, during a 3D printing or other manufacturing process. Alternatively, one or more line eyes may comprise one or more separate components (e.g., an insert, tube and/or eyelet formed of plastic, metallic or other material and inserted or embedded, partially or entirely through, or otherwise affixed to or within, the trunk 812) and/or an aperture formed in the trunk 812 (e.g., a trunk that provides buoyancy to the bobber 810 via one or more air pockets and/or incorporation of one or more or a combination of solid buoyant materials, as described herein) by drilling, insertion, plugging or other means. In some embodiments, the first line eye 820 is located on the proximal side 823 of the trunk 812 and the fourth line eye 834 is located on the distal side 825 of the trunk 812.

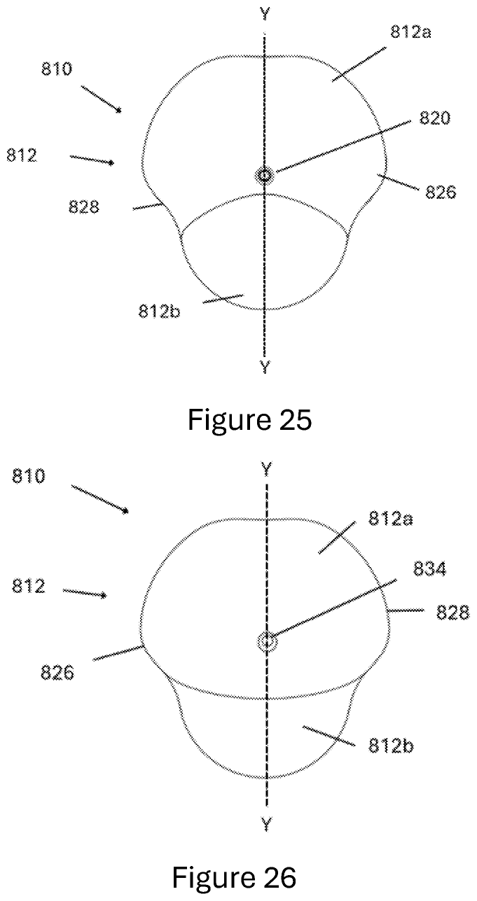

Continuing with the description of structural features, FIG. 25-FIG. 28 show elevation views of an inventive bobber 810 having a trunk 812, according to multiple embodiments and alternatives. Again, these views illustrate the asymmetric geometry of the bobber 810 and trunk 812. As with other figures, FIG. 25 identifies a first lateral side (sometimes referred to as right side) 826 and a second lateral side (or left side) 828 of the bobber 810. Likewise, the proximal side 823 and distal side 825 of bobber 810 are labeled in FIG. 28, among other figures. In some embodiments as shown FIGS. 23, 34, 35, 36B, 36C and 37, the second line eye 822 is located on the top portion 812a of the trunk 812, and the second line eye 822 is located closer to the proximal side 823 of the trunk 812 than is the third line eye 832.

Now with reference to FIG. 25—together with FIGS. 22, 23, 24, 27, 28 and 36B in one possible use case of the bobber 810, an angler (not pictured) will be positioned relative to the bobber as shown in FIG. 25, with the first line eye 820 and the proximal side 823 of the bobber generally disposed closer to or facing in the general direction of the angler. In such a position, the distal side 825 would be disposed further from or facing in the general direction away from the angler.

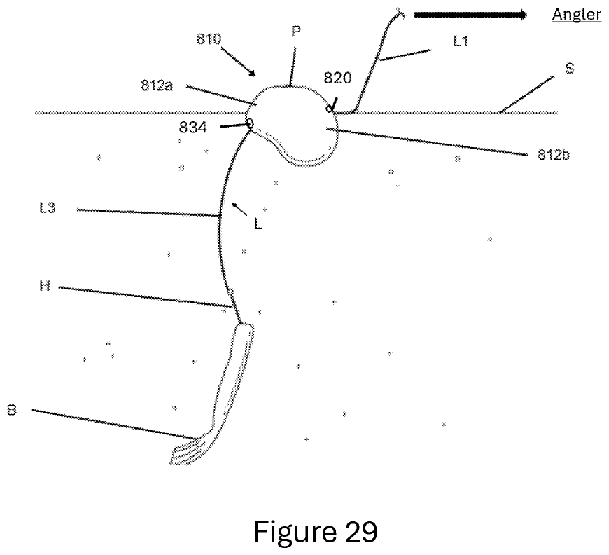

With reference to the first line eye 820, one can visualize the bobber 810 from different views, for example by noting differences in where the first line eye 820 is positioned (e.g., with respect to FIGS. 23, 25, 27, 28, 29, 30, 31, 32, 33, 34, 35 and 36A) or, in the case of FIGS. 24 and 26, where the first line eye 820 is not seen in either the bottom-side plan view of the bobber 810 and trunk 812 or the distal side 825 elevation view of the bobber 810 and trunk 812, respectively. FIG. 29 illustrates some aspects of the bobber 810 in use, including its attachment to a fishing line, L, and to a fishing line stop element, P. FIG. 29 further illustrates the trunk 812 as including a top portion 812a having a generally curvilinear shape that floats above the surface, S, of the water and the lower weighted bottom portion 812b that generally sits below the surface, S, of the water. As shown in FIG. 29, the area below the line indicating the surface of water, S, contains some small circles to indicate a water environment (e.g., bubbles or sediment) existing below the water surface, S. In some embodiments, the lower portion 812b of the trunk 812 is located approximately at or below the line eyes, 820, 822, 832, 834, relative to a height dimension of the trunk 812 that is generally parallel to the vertical yaw axis Y-Y.

FIG. 29 depicts possible positioning of the bobber 810 relative to the water surface, S, in relation to bait, B, attached to a hook, H, which is attached to the fishing line, L, at a position along a segment of the line, L, designated L3 to indicate this segment of line, L, is closest to the hook H. Another segment L1 of the fishing line, L, is also shown in FIG. 29, with this segment L1 positioned closer to an angler (not shown) who has cast the line, L, and bobber 810 into the water, and another segment of the fishing line, L2 (as shown in FIGS. 22 and 35), positioned between the second- and third-line eyes 822, 832, as described below. While segments of the fishing line L are identified separately in some figures, the intent is to show they are different parts of the same fishing line L. Also, for the avoidance of doubt, unless and only to the extent expressly recited otherwise in the claims, the bait B, hook H, line L, surface S of the water, and stop element P, are shown for illustrative purposes only and do not limit what is claimed herein.

As used herein, the term “stop element” P generally is to be considered broadly to refer to a body—that is, a physical mass or a structure through which a fishing line L may pass—having a transverse interface with respect to the line L that can be positioned at, substantially- or approximately-perpendicular to a longitudinal (lengthwise) axis of the fishing line L. The following are structures and materials, by way of non-limiting example only, which may form a stop element: a piece of braided string, a bead (e.g., a rubber, plastic, or metal bead comprised of any of the foregoing and/or other materials), and a sleeve (e.g., a rubber or plastic sleeve).

For example, suitable stop elements (also referred to herein as a “bobber stops,” “stoppers,” “string ties,” “line limiters,” or “line-limiting structures”) for constraining the travel of a fishing line L so as to suspend a hook H, bait B, and/or weight at a substantially fixed depth beneath the surface S of the water are well known in the art. Nonlimiting examples of suitable stop elements for use with present embodiments include Rod-N-Bobb's® Slotted Sleeve Bobberstops, which are fishing terminal tackle products manufactured and distributed by Rod-N-Bobb's®, Inc. of Augusta, Wisconsin. Such a stop element P is a pre-configured string or filament knot assembly configured to be slidably positioned on a fishing line L and, upon tightening, to frictionally engage the line L at a selected depth-setting position, thereby limiting travel of a bobber along the line L. The stop element P may be provided with a hollow, slotted cylindrical loading sleeve that facilitates threading of the fishing line L through a knot assembly of the stop element P prior to deployment, the slotted configuration permitting removal of the sleeve after the knot assembly has been transferred onto the fishing line L. Such stop elements P generally are suitable for use in both freshwater and saltwater fishing environments, have at least a first hole and a second hole for the fishing line L to pass through so the stop element P can be secured to the bobber, and are capable of being repositioned along the fishing line L to selectively adjust the effective fishing depth of the bobber.

It should be understood that the “stop element” P is not limited to any single structural form. Rather, the term is intended to encompass any structure, device, or modification to the line L that creates a localized increase in effective diameter or friction sufficient to limit movement relative to the bobber 810. Non-limiting examples include: a) molded or extruded polymer beads including, but not limited to, rubber fishing bobber stopper stops or beads; b) metallic or plastic crimp-on weights or limiters; c) wrapped or braided filaments; d) adhesive or thermally bonded protrusions; and/or d) mechanical clamps or pin-and-sleeve assemblies.

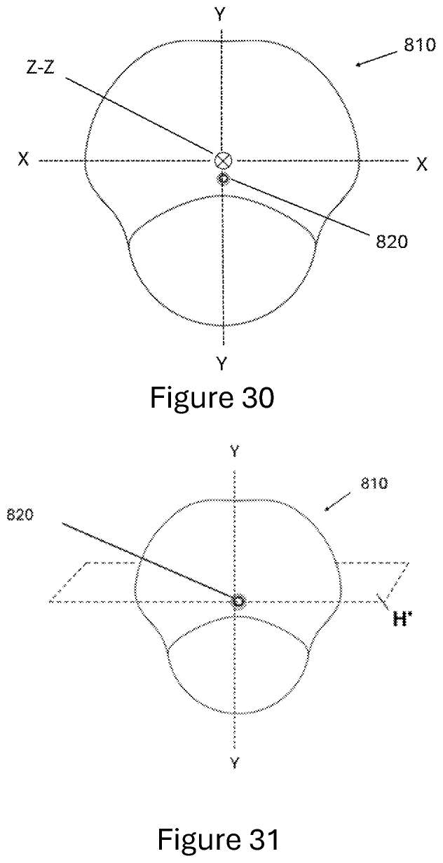

With continued reference to FIG. 29, showing the bobber 810 prior to a fish strike, once a fish engages the bait B and places a force on the fishing line, L, several kinds of movement can happen with the bobber 810, some of which are referenced by the axes shown in FIG. 30. With reference to the first line eye 820, these axes are a horizontal or pitch axis, also referred to as X-X; a central vertical or yaw axis, also referred to as Y-Y; and a roll axis, also referred to as Z-Z. Certain movement that occurs in the bobber 810 after a fish strike is associated with rotation around or about one or more of these axes, as will be discussed further. Also, conventional bobbers such as illustrated in FIG. 21 (prior art) have substantially symmetric geometries that require more resistance or tension to be applied in the fishing line L between the bobber 5 and the surface, S, of the water, to provide a visual and discernible indication of a fish strike to the angler because of the evenly distributed surface area of the bobber (in other words, the fish is required to strike and pull the bait B and/or hook H downward with sufficient force so as to at least partially submerge, twist or rotate the round conventional “beach ball” style bobber so as to provide the angler a visual and discernible indication of a fish strike. Thus, when using conventional style bobbers, such as that generally shown in FIG. 21, a fish must apply a relatively significant force to the bait B and/or hook H such that sufficient tension is applied in the portion of the fishing line L extending beneath the surface of the water so as to provide a visual and discernible indication, e.g. an at least partial submersion of the bobber, of a fish strike to the angler. Consequently, the fish is provided an opportunity to sense tension in the line L and release or “spit out” the hook H and bait B.

By comparison, the cantilever-like action provided by present embodiments, due in part to their uneven, or asymmetrical, weight and surface area distributions, reduces the threshold of tension required in the fishing line L in order to provide a visual and discernible indication of a fish strike to the angler. In turn, upon striking or “nibbling” at the bait B and/or hook H, a fish feels less resistance in the line L, which decreases the likelihood of the bait B and/or hook H becoming dislodged upon an angler setting the hook due to the fish sensing a false presentation and discontinuing the strike.

Using the same outline as FIG. 30, the next figure, FIG. 31, illustrates a conceptual horizontal plane, H′, shown extending through the trunk 812 perpendicular to the vertical yaw axis Y-Y, again indicative of the bobber 810's asymmetric geometry because the plane, H′, divides the bobber 810 into two portions—one above the plane H′ and one below the plane H′—which exhibit different geometric size and shape and thus lack equivalent geometric proportionality. The positioning of the plane, H′, in FIG. 31 is generally near or approximate to a vertical midpoint of the bobber 810 relative to a height dimension of the trunk 812 that is generally parallel to the vertical yaw axis Y-Y. Illustrations provided in the figures are not intended to limit the embodiments to precise arrangements or dimensions as illustrated. Generally, however, the trunk 812 of the bobber 810 has a top portion 812a and a bottom portion 812b as denoted in FIGS. 22-28, at least. In some embodiments, the top portion 812a is characterized by having i) a buoyancy greater than a buoyancy of the bottom portion 812b; and the bottom portion 812b characterized by i) a weight and/or density greater than the top portion 812a, ii) a buoyancy less than that of the top portion 812a, and iii) a lobulated curvilinear geometric shape.

Now referring back to the bobber 810 in operation, as seen in FIG. 29, a fish striking from below the surface S of the water will generally tend to exert an at least partially downward force on the fishing line L that will be initiated along segment L3 due to its proximity to the hook H and bait B as seen in FIG. 29. To illustrate a kind of movement in the bobber 810 that may result upon a fish strike, FIG. 32 shows a pitch axis, X-X, with the first line eye 820 and the fourth line eye 834 seen on opposing sides in this view. As perhaps best seen in FIG. 32 and FIG. 36B, respectively, the bobber 810 exhibits a counterbalancing of weight between the heavier proximal side 823 and the distal side 825 and between the heavier and denser bottom portion 812b and top portion 812a. This uneven weight distribution functions such that, upon a fish striking the bait, B, on the hook, H, the bobber 810 rotates about or around a center point or axis (e.g., vertical yaw axis Y-Y, pitch axis X-X, and/or roll axis Z-Z) the trunk 812 in a cantilever-like action, thereby providing a visual and discernible indication to the angler of a fish strike, in which the direction of the force applied on the fishing line L determines the direction of the rotation. Optionally, such a visual and discernible indication may be more pronounced when contrasting and/or other colors and/or patterns are provided on one or more of the outer surfaces of the top portion 812a and/or lower weighted portion 812b of the trunk 812, to enhance a visual and discernible indication to the angler of a fish strike.

Accordingly, applying an at least partially downward force on segment L3 (as shown in FIG. 29) results in rotation of the bobber 810 around or about horizontal pitch axis X-X (as shown in FIGS. 30 and 32), i.e., such downward force within the line L causes the bobber 810 to pitch forward in the direction indicated by rotational arrow 861 in FIG. 32. Removal of such at least partially downward force within the line L, as when the hook H and/or bait B separate from the line L such that the force from the fish strike is no longer applied within the line L, will tend toward the opposite movement around or about horizontal pitch axis X-X, as indicated by rotational arrow 863 in FIG. 32. More generally, a fish strike may produce a combination of at least two kinds of rotational movement, such that an at least partially downward force applied to the fishing line L along segment L3 causes the trunk 812 to rotate around or about one or more axes that is/are perpendicular to the vertical yaw axis (Y-Y), e.g., around or about horizontal pitch axis X-X and/or roll axis Z-Z, thereby indicating the direction of force on the fishing line L along segment L3 based on the direction(s) of rotational (e.g., pitch and/or roll) movement. As seen in several figures, in use, the vertical yaw axis Y-Y generally is perpendicular to the surface, S, of the water prior to a fish strike.

A force applied to the line L along segment L3 as a result of a fish strike upon the bait B and/or hook H may also create rotational movement in the bobber 810, for example, (a) a rotational movement about the vertical yaw axis, Y-Y, as illustrated in FIG. 23, in a direction according to rotational arrows 865 and/or 867 depending on the direction of the force applied to the bait B and/or hook H along segment L3 of the line L. As mentioned, such a force applied along segment L3 of the line L may also create a roll movement in the fishing bobber 810 about roll axis Z-Z, as represented in FIG. 30 and FIG. 33 and associated with rotation according to rotational arrows 868 and/or 869 in FIG. 33. The rotational arrows depicted in FIG. 32 (861, 863) and FIG. 33 (868, 869) relate to potential rotational movement of the bobber 810 about the pitch axis X-X and/or the roll axis Z-Z as depicted in FIG. 32 and FIG. 33, respectively.

The asymmetric geometry and weight distribution of the bobber 810 provide enhanced sensitivity to external forces applied along the line L, and particularly to external forces applied along segment L3 of the line L, such as a strike by a fish upon the bait B and/or hook H. Unlike a conventional spherical bobber (e.g., the conventional, prior art “beach ball” type bobber shown in FIG. 21), which requires a threshold of downward and/or horizontal (lateral) force to achieve vertical and/or horizontal (lateral) displacement sufficient to provide a visual and discernable indication of a fish strike to the angler, the bobber 810 advantageously is configured to respond to minimal force applied along the fishing line L. Conventional bobbers generally require a force vector substantially perpendicular to the surface S of the water to overcome buoyancy and provide a visual signal via vertical displacement. In contrast, the bobber 810 translates even non-perpendicular or light “nibbles”—including instances in which a fish may engage and move the bait B and/or hook H in a relatively upward vertical direction toward the surface S of the water—into observable rotational kinetic energy. This reduction in the force required for visual feedback allows an angler to detect fish strikes that would otherwise fail to sufficiently displace a conventional bobber so as to provide a visual and discernible indication of a fish strike.

It will be appreciated that the various movements described in FIG. 32 and FIG. 33, as well as the yawing in FIG. 23, can be considered from the perspective of the angler. For example, as seen in FIG. 29, suppose the angler is closest to line segment L1. Suppose further the angler and the fishing bobber 810 are oriented so the first line eye 820 is squarely facing the angler, whether submerged or above the surface S of the water. The rotational movement in a forward pitching motion 861 as shown in FIG. 32 can be thought of as the lower weighted portion 812b of the trunk 812 of bobber 810 pitching toward the angler (corresponding with the upper portion 812a of the trunk 812 of the bobber 810 pitching away from the angler). Alternatively, a pitch in a substantially opposite rotational movement, as depicted by rotational arrow 863 (as also shown in FIG. 32), may occur, as previously described (e.g., if a fish were to take the bait B on the hook H (collectively, the “suspended bait”) and carry it upward toward the surface S of the water, thereby reducing tension in segment L3 of the line L. Likewise, in the hypothetical positioning described here, a force applied upon segment L3 of the line L may cause the bobber 810 to roll or tilt generally in a direction of rotational arrow 868, as shown in FIG. 33 (if such force is applied downward from the surface S of the water and toward the first lateral (or right) side 826 of the bobber 810 from the angler's perspective, as generally shown in FIG. 33) or generally in a direction of rotational arrow 869 (if such force is applied downward from the surface S of the water and toward the second lateral (or left) side 828 of the bobber 810 from the angler's perspective, as generally shown in FIG. 33). From the angler's perspective (again, as generally shown in FIG. 33), this would appear as a roll of the bobber 810 either to the left or to the right, respectively. Rotation of the bobber 810 in a direction of arrows 865 and/or 867 (as shown in FIG. 23) constitutes a yawing movement. As previously noted, this can be seen in FIG. 23, for example, with the bobber 810 turning about the vertical yaw axis Y-Y in that figure.

In practice, when fishing, often the movement of bobber 810 upon a fish strike will be a combination of one or more rotations around or about one or more of the aforementioned axes, depending on the orientation of the fish relative to the bobber 810, the lateral and vertical directions in which the bait B and/or hook H are being pulled, and the orientation of the bobber 810 in the water. The concepts of pitch, yaw, and roll are meant to illustrate in non-limiting and exemplary ways the kinds of rotational movement the bobber 810 may experience when a fish strike occurs. A combination of such movements may provide a directional visual and discernable indication and/or a visual bait presence indication as disclosed herein that are advantageous to the angler. Given the nature of fishing, it will be understood that following a fish strike, the rotational movement may also be accompanied by translational movement. Also, the rotational arrows 861/863, 865/867, and 868/869 are not meant to imply or require any minimum degree of rotation about or around pitch axis X-X, vertical yaw axis Y-Y and/or roll axis Z-Z, respectively, to provide the angler an advantageous directional visual and discernible indication and/or a visual bait presence indication. Rather, movement in the bobber 810 may result in any degree of rotation about or around one or more of the aforementioned axes and/or respective rotational arrows so as to provide a visual and discernible indication to the angler of a fish strike.

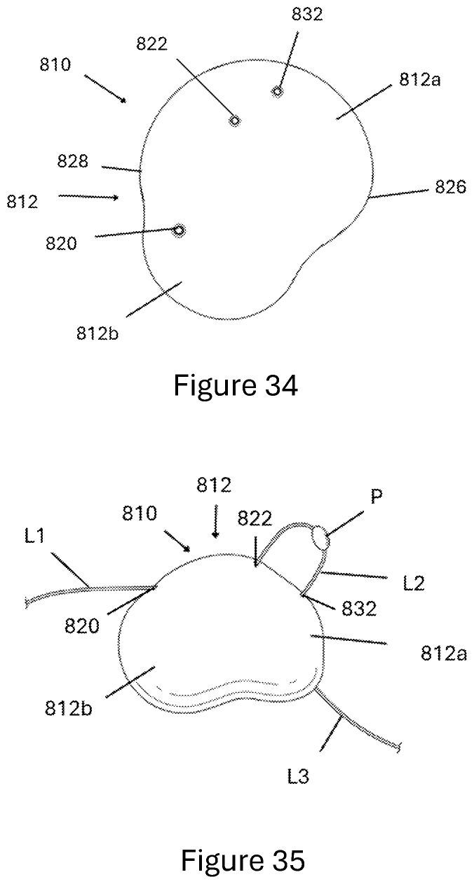

Certain structures are depicted in FIG. 34 which have been referenced in previously discussed figures. For example, in FIG. 34 the second line eye 822 and third line eye 832 are seen in relation to first line eye 820, along with first lateral side (or right side) 826 and second lateral side (or left side) 828 of the trunk 812. In some embodiments, the first through fourth line eyes (820, 822, 832, and 834 respectively) are configured to attach the bobber to the fishing line. Each of the four line eyes is an opening in the outer surface of the trunk 812 that permits entry or exiting of the fishing line into or out of the interior of the trunk 812. FIG. 35 illustrates the fishing bobber 810 with a fishing line, L, inserted into, through, and out of the trunk 812, with a fishing line stop element, P, attached to the fishing line, L. More particularly, in an exemplary use case, L1 is the segment of line L that would be closest to an angler who has cast the line. The line is inserted through first line eye 820 (seen in other figures) to enter the interior of the trunk 812, then exits the trunk at second line eye 822. A stop element, P, may then be positioned on the line L along segment L2—which is the portion of the line L between the second and third line eyes, 822 and 832, respectively—before the line L is inserted to reenter the interior of the trunk 812 at the third line eye 832. Finally, the line L exits the trunk 812 at fourth line eye 834 (seen in other figures). Having now been attached to the bobber 810, the line L can be attached to a hook H and bait B along segment L3 of the line L.

While illustrations contained in the figures often show at least three line eyes and various descriptions of embodiments are mentioned with four line eyes, the scope of embodiments include those wherein the bobber 810 has less than four line eyes. For example, with reference to FIG. 22, one could—either (a) eliminate either line eye 822 or line eye 832, or (b) merge second and third line eyes (822, 832) into one line eye, with the effect of either options (a) or (b) essentially being that second and third line eyes (822, 832) are combined or merged into a single line eye positioned near the top of the bobber 810. If one were to eliminate line eye 832, then in operation the fishing line L accordingly would pass through line eyes 820, 822, and 834 instead of passing through all four line eyes.

Optionally, one could eliminate both line eye 822 and line eye 832. This would result in a bobber 810 that has only a first line eye 820 and a second line eye (depicted in the accompanying figures as 834) on or near the proximal and distal sides, 823 and 825, respectively, of the bobber 810. In such embodiments, an internal channel may be formed between and otherwise connect line eyes 820 and 834 as the fishing line L enters the trunk 812 at line eye 820 and exits at line eye 834. Such an internal channel similar in form to internal channel 854 and/or internal channel 856 as illustrated in FIG. 37 may be oriented as a straight (i.e., a horizontal or substantially horizontal) path through the interior of the trunk 812 between line eyes, 820 and 834. However, such internal channel(s) (854, 856) need not be straight (as described immediately above) and, instead, can be curved, spiraled, angled, or follow any tortuous path through a bobber (e.g., bobber 810) through which an angler may pass a fishing line L from a proximal side through a distal side thereof. For example, one or more internal channel(s) (e.g., 854 and/or 856) may define an internal path or channel within the trunk 812 of the bobber 810 that generally defines an inverted U-shape, V-shape, S-shape or other contour in which a fishing line L may internally pass upon entry at an initial line eye or aperture near a proximal side (e.g., 823) of the trunk 812 of the bobber 810 (e.g., first line eye 820), and upon exit at or near another line eye or aperture near a distal side (e.g., 825) of the trunk 812 of the bobber 810 (e.g., line eye 834 as generally illustrated in various Figures, for example, FIGS. 22-24, 26-28, 32, 36B, 36C and 37)

Now turning to the unequal weight distribution of the fishing bobber 810, FIG. 36B is a cross-sectional view of an exemplary fishing bobber taken along line A-A shown in FIG. 36A. As shown in this and other figures, the bottom portion 812b of the trunk 812 is denser than the top portion 812a, producing an unequal weight distribution across the bobber 810 with respect to the proximal and distal sides (823, 825), respectively, due to the lower weighted portion 812b of the trunk 812 being heavier than the top portion 812a and laterally offset relative to vertical yaw axis Y-Y.

In some embodiments, the trunk 812 of the bobber 810 is configured as an asymmetric body having a geometry that is asymmetric with respect to the vertical yaw axis Y-Y when the bobber 810 is viewed from left- and/or right-side elevation views as shown in FIGS. 27 and 28; the perspective view of FIG. 32; and the cross-sectional views as shown in FIGS. 36B and 36C. In these and other embodiments as described herein, the lower weighted portion 812b of the trunk 812 is formed, shaped, dimensioned, weighted, and/or otherwise configured such that the center of mass of the lower weighted portion 812b—and, consequently, the center of mass of the bobber 810 as a whole—is laterally offset from the vertical yaw axis Y-Y.

As gradient arrows, G, in FIG. 36C depict, the lower weighted portion 812b of the trunk 812 has a center of mass that is laterally offset from the vertical yaw axis Y-Y toward the proximal side 823 (as shown in other figures) of the bobber 810 and trunk 812. The resulting gradient distributes the weight of the bobber 810 toward the lower weighted portion 812b such that the center of mass of the trunk 812 is positioned below a vertical midpoint of the height of the trunk 812, where the height is a dimension of the trunk 812 that is generally parallel to the vertical yaw Y-Y axis. In some embodiments, the unequal weight distribution also exists horizontally by the proximal side 823 of the trunk 812 being heavier than the distal side 825, given the denser geometry of the lower portion 812b of the trunk 812 as seen in FIG. 36B and FIG. 32, as well as in other figures.

In addition to its lateral offset from the vertical yaw axis Y-Y, the center of mass of the bobber 810—and more particularly the center of mass of the lower weighted portion 812b—is further characterized by its vertical position along, or substantially parallel to, the vertical yaw axis Y-Y, which axis is also generally parallel to the height dimension of the trunk 812 as a whole. As used herein, the “height” of the trunk 812 shall mean the overall linear dimension of the trunk 812 measured along a direction that is generally parallel to the vertical yaw axis Y-Y, from the lowermost extent of the trunk 812 to the uppermost extent thereof.

In some embodiments, the bobber 810 exhibits a center of mass that is disposed at a vertical position approximately at or below the midpoint of the height of the trunk 812 as measured along a direction parallel to the vertical yaw axis Y-Y. As will be understood by one having ordinary skill in the art, this relatively downward displacement of the center of mass along the vertical yaw axis Y-Y, in combination with the lateral offset of the center of mass toward the proximal side 823 of the bobber 810, cooperate to establish static and dynamic equilibrium conditions whereby the bobber 810 achieves and maintains its orientation and a fixed depth when deployed in an aquatic environment with a variance of weight attached thereto along segment L3 of the fishing line L in the form of a hook H, bait B, and/or additional weight, for example, but not limited to, split shot type sinker(s).

As used herein, a “center of buoyancy” of the bobber 810 refers to the geometric centroid of displaced water volume—i.e., the volume of the aquatic medium displaced by the submerged portion of the bobber 810 when the bobber 810 is deployed at or below the surface S of the water—which centroid represents the point through which the net upward buoyant force acts upon the bobber 810 in accordance with Archimedes' principle. The center of buoyancy of the bobber 810 is expressly distinguished from, and shall not be construed as being synonymous with, the center of mass of the bobber 810, the latter representing the point through which the net gravitational force acts upon the bobber 810. As will be appreciated by one having ordinary skill in the art, the spatial relationship between the center of buoyancy and the center of mass governs the rotational stability and equilibrium orientation of the bobber 810 when deployed.

As perhaps best illustrated by reference to FIGS. 29, 30, 31, 36A, and 36B, the center of buoyancy of the bobber 810 is determined by the geometric centroid of the total displaced volume of the trunk 812, including the displaced volumes attributable to the top portion 812a and the lower weighted portion 812b, as well as the influence of any internal voids or air pockets—for example, the first air pocket 816a, the second air pocket 816b, and the third air pocket 816c which contribute to the overall displaced volume of the bobber 810 in a manner that is a function of the depth of submersion of the bobber 810 within the water.

According to exemplary embodiments, the vertical position of the center of buoyancy of the bobber 810, as measured in a direction along or generally parallel to the vertical yaw axis Y-Y, is disposed above the center of mass of the bobber 810. More specifically, the center of buoyancy of the bobber 810 may be disposed at a vertical position that is above the lower weighted portion 812b and that is generally within the region of the trunk 812 corresponding to the top portion 812a, or at or near the boundary between the top portion 812a and the lower weighted portion 812b of the trunk 812.

It is further contemplated that the lateral offset of the center of mass of the bobber 810 toward the proximal side 823 of the trunk 812, in combination with the vertical separation between the center of buoyancy and the center of mass along the vertical yaw axis Y-Y, cooperate to establish and maintain the desired asymmetric static equilibrium of the bobber 810 as described herein when deployed. Accordingly, this may configure the bobber 810 to assume and maintain a predetermined, fixed orientation with the hook H and bait B deployed at a desired depth beneath the surface S of the water as determined by the angler, thereby providing heightened sensitivity to fish strikes detectable at the surface S of the water. A precise spatial relationship between the center of buoyancy and the center of mass—in both the lateral direction (relative to the vertical yaw axis Y-Y and with respect to the proximal side 823 and distal side 825 of the trunk 812) and the vertical direction (relative to the height of the trunk 812 measured along, or substantially parallel to, the vertical yaw axis Y-Y)—may vary across embodiments consistent with the foregoing description. Accordingly, this unequal distribution vertically and horizontally among weight, mass, and buoyancy results in a spatial relationship that achieves an advantageous equilibrium behavior of the bobber 810 relative to the aquatic environment in which it is being used.

As shown in the cross-sectional view of FIG. 36B, the bobber 810 may include a first internal elongated channel 836 which extends along an interior portion of the trunk 812 near the proximal side 823 of the bobber 810 to fluidly connect the first line eye 820 and the second line eye 822, creating a passage through the bobber 810 configured to receive and allow a fishing line L to slidably pass therethrough. The bobber 810 may include a second internal elongated channel 838 which extends along an interior portion of the trunk 812 near the distal side 825 of the bobber 810 to fluidly connect the third line eye 832 and the fourth line eye 834, creating a passage through the bobber 810 configured to receive and allow a fishing line L to slidably pass therethrough. In some embodiments, each internal channel (836, 838) is formed integrally within the trunk 812. As with the line eyes, this may occur during a 3D printing or other manufacturing process. However, in other embodiments, one or more internal channels may comprise one or more separate components (e.g., a passage formed integrally within the trunk 812 during a 3D printing or other manufacturing process but not extending to an internal surface on the right, or first lateral, side 826 or left, or second lateral, side 828 of the bobber 810). Alternatively, one or more internal channels may compromise one or more separate components, such as one or more tubes, 846 and/or 848, as generally shown in FIG. 37. Such internal tube(s) or channel(s) may be formed of plastic, metallic or other material that is inserted, embedded, affixed, or otherwise positioned through the trunk 812 of the bobber 810 to connect one or more line eyes (820, 822, 832 and/or 834) and allow a fishing line L to slidably pass therethrough.

With regard to FIGS. 22-45B, it will be appreciated that the scope of embodiments herein include structures and features from earlier figures combined with the structures and features described in FIGS. 22-45B. By way of non-limiting example only, the inventive bobber 810 may be configured with one or more external elongated channels that the fishing line L is passed through. Such an external channel is labeled 622 in FIGS. 17 and 18 and can be located on an external surface of the trunk 812. Such an external channel may take the place of or be in addition to one or more internal channels connected by two or more line eyes 820, 822, 832, and/or 834 as described herein. Accordingly, two or more line eyes define separate openings through which the fishing line L may be routed, wherein each line eye may be formed in the outer surface of the trunk 812 or positioned along the outer surface of the trunk 812. Each line eye defines an aperture configured to permit passage of the fishing line L into, out of, and/or along the trunk 812.

Still further, external and/or internal line eyes and/or external and/or internal channels through which a fishing line L may pass include, but are not limited to those generally illustrated and/or described herein, including, but not limited to: (a) external line eyes 420, 422 as illustrated in FIGS. 9-12; (b) external line eye 520 and internal channel 522 as illustrated in FIG. 13-16; (c) external line eye 620 and external channel 622 as illustrated in FIGS. 17-19; and/or (d) first and second external line eye(s) and/or channel(s) 720, 222, respectively, as illustrated in FIGS. 20A and 20B.

External line eyes and/or external channels, alone or together, may replace or supplement internal line eyes and/or channels connected by two or more of line eyes 820, 822, 832, and/or 834 as described herein.

In some embodiments, infill is used in various portions of the trunk such as bottom portion 812b, while alternatively, the interior of the trunk 812 may be hollow except the internal tubes or channels (e.g., 836, 838) connecting one or more line eyes on the outer surface of the bobber 810. As used herein, the term “infill” refers to the internal structure disposed within the interior of the trunk 812 of the bobber 810. The infill may comprise any internal geometry, pattern, or material arrangement—including, without limitation, a solid fill, a partial fill, a lattice structure, a honeycomb pattern, a gyroid pattern, a rectilinear pattern, a triangular pattern, a concentric pattern, or any combination thereof—that occupies all or a portion of the hollow interior space within the trunk 812 of the bobber 810. The infill density may range from approximately 0% (i.e., either fully or substantially hollow) to approximately 100% (i.e., fully or partially solid, e.g., if a portion or all of the interior volume of the trunk 812 is comprised of a solid or semi-solid buoyant material (non-limiting examples of which are described below), and may be uniform or may vary across different regions of the trunk 812 of the interior of the bobber 810.

In some embodiments, the infill serves one or more purposes of structurally reinforcing the bobber 810, controlling its buoyancy by regulating the volume of air or gas retained within the interior of the trunk 812 of the bobber 810, and/or tuning the weight distribution and balance characteristics of the bobber 810. The geometry, density, pattern, and material composition of the infill may be selected and adjusted to achieve desired performance characteristics, including but not limited to buoyancy, sink depth of the hook H, bait B, and/or additional weight attached to the line L beneath the surface S of the water, e.g., split shot weight(s), (c) casting weight, (d) durability, and/or other desired performance characteristics of the bobber 810.

Accordingly, infill may be used to wholly or partially fill an interior space of the trunk 812 of the bobber 810. Exemplary infill materials within the scope of multiple embodiments and alternatives of the bobber described herein included, but are not limited to, balsa wood, cork, cedar, paulownia, basswood, white pine, and similar low-density natural wood materials; bamboo fiber composites, kapok fiber, balsa fiber composites, and other natural fiber cellulosic or lignocellulosic materials processed into solid or semi-solid form; polystyrene (EPS, commonly known as Styrofoam™), extruded polystyrene (XPS), expanded polypropylene (EPP), expanded polyethylene (EPE), polyurethane foam (open-cell or closed-cell), polyvinyl chloride (PVC) foam, ethylene-vinyl acetate (EVA) foam, acrylonitrile butadiene styrene (ABS) foam, and similar expanded or extruded polymer foams; lightweight, low-density composite structures such as microspheres or microballoons (e.g., glass, ceramic, or polymer microspheres) embedded within a binder or matrix material; silica aerogel, carbon aerogel, and polymer-based aerogels; polymer beads, polymer microspheres, and foamed thermoplastic elastomers; neoprene foam, EPDM foam, natural rubber foam, and similar rubber foam or elastomeric cellular materials; low-density filament materials formulated for fused deposition modeling (FDM) or other additive manufacturing processes, such as lightweight PLA composites, foamed TPU filament, and wood-fill or cork-fill polymer filaments; and other natural, synthetic, or composite material, whether now known or hereafter developed, having a suitable bulk density to impart, enhance, contribute to, or maintain a buoyancy of the bobber 810. In some aquatic environments, a bulk density of such materials which is less than that of water (i.e., less than approximately 1.0 g/cm³ ) would represent a suitable property for these purposes.

Additionally, the solid or semi-solid buoyant material may be disposed within the interior space of the trunk 812 of the bobber 810 as a single unitary mass, as a plurality of discrete pieces or particles, or as a combination thereof. The solid or semi-solid buoyant material may substantially fill the entire interior space of the trunk 812 of the bobber 810, or may occupy only a portion thereof, with the remaining interior space of the trunk 812 of the bobber 810 occupied by air, another gas, or a combination of materials. In some embodiments, the solid or semi-solid buoyant material may be co-printed, molded, cast, injected, inserted, adhered, or otherwise introduced into the interior space of the trunk 812 of the bobber 810 during or after the manufacturing process. The type, density, volume, and placement of the solid buoyant material may be selected to achieve a desired buoyancy level, weight distribution, sink depth, casting weight, durability, or other performance characteristic(s) of the bobber 810.

As also shown in FIG. 36B, the top portion 812a of the trunk 812 may include one or more internal air pockets 816 to keep the top portion 812a of the trunk 812 floating above the surface S of the water. The one or more air pockets 816 may comprise hollow cavities (0% infill) formed during a 3D printing or other manufacturing process and/or solid or semi-solid buoyant material as described above. In some embodiments, again with reference to FIG. 36B, the trunk 812 may include three separate, distinct air pockets 816, a first air pocket 816a positioned within the top portion 812a of the trunk 812 near the proximal side 823, a second air pocket 816b positioned within the top portion 812a of the trunk 812 near the distal side 825, and a third air pocket 816c positioned above the lower weighted portion 812b of the trunk 812 extending vertically upward into the top portion 812a between the first and second internal channels 836 and 838.

In some embodiments, a fishing bobber according to multiple embodiments and alternatives described and provided for herein is included as a kit. Such a kit may include one or more fishing line stop element(s), P. Such a kit may include a plurality of fishing bobbers as described herein, having any of the structural features provided for.

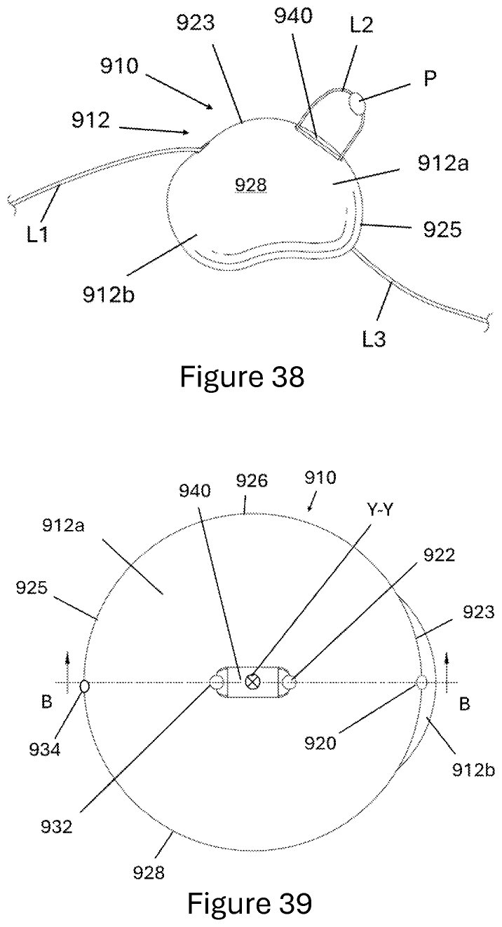

Now with reference to FIG. 38-FIG. 41 a bobber 910 is shown according to further preferred embodiments, wherein like reference numerals indicate like components. The bobber 910 according to these embodiments is like the embodiments described above and shown in FIG. 22-FIG. 37 wherein like reference numerals indicate like components. The inventive bobber 910 may have an indentation 940 formed in the outer surface of the bobber 910 on the top portion 912a of the trunk 912, which in some embodiments extends between the second line eye 922 and the third line eye 932. In some embodiments, the indentation 940 is configured with dimensions to allow a stop element P attached to a fishing line L to be pulled taut and put at rest (i.e., be seated) at least partially within the indentation 940. Similar to earlier figures, the bobber 910 includes a trunk 912, a top portion 912a of which has a generally curvilinear shape and floats above the surface S of the water and a lower weighted portion 912b that is designed to sit below the surface S of the water when in use. The bobber 910 further comprises a proximal side 923, a distal side 925, a first lateral (or right side) 926 and a second lateral (or left side) 928. The bobber 910 may include a first line eye 920 located horizontally on or near the proximal side 923 of the bobber 910 between the top portion 912a and the lower weighted portion 912b of the trunk 912, a second line eye 922 located horizontally on or near the proximal side 923 of the bobber 910 and vertically on or near the outer surface of the top portion 912a of the trunk 912, a third line eye 932 located horizontally on or near the distal side 925 of the bobber 910 on or near the outer surface of the top portion 910a of the trunk 912, and a fourth line eye 934 located horizontally on or near the distal side 925 of the bobber 910 between the top portion 912a and the lower weighted portion 912b of the trunk 912.

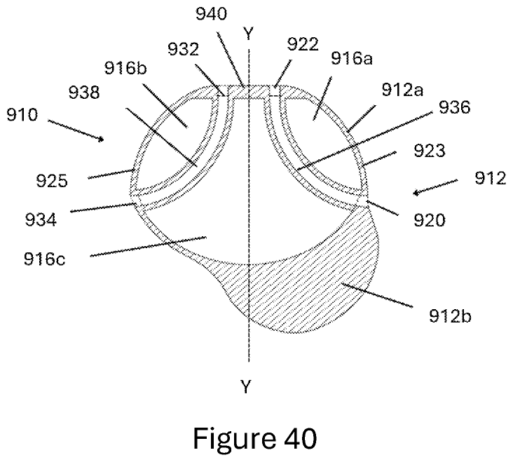

FIG. 38 illustrates a bobber 910 according to present embodiments having a buoyant trunk 912. Again, rather than having a simple geometric outer shape, such as in the case of conventional bobbers comprising symmetric or substantially symmetric hemispherical portions as generally illustrated in FIG. 21 (prior art), the accompanying figures depicting the bobber 910 (as perhaps best shown in FIGS. 40, 41, and 42) illustrate that—from a side elevational view of the bobber 910, wherefrom the viewing angle is oriented at, approximately, or generally perpendicular to either (a) the first lateral (or right side) 926, or (b) the second lateral (or left side) 928 (as labeled in FIG. 38) of the bobber 910 (in other words, when the viewing direction of the bobber 910 is substantially or generally orthogonal to the roll axis Z-Z represented in FIG. 30 and FIG. 33)—the outer surface of the bobber 910 defines an asymmetric, generally lobulated form with a curvilinear geometry that is unevenly distributed as described previously. More specifically, the top portion 912a is formed as a primary bulbous portion that transitions on the proximal and distal sides (923, 925) via smooth, continuous, asymmetric compound curvatures into the lower weighted portion 912b. Again, the top portion 912a and bottom portion 912b are configured to be attached to a fishing line, L, which is inserted through one or more fishing line stop elements, each of which are depicted individually in the accompanying figures as P, such that when the fishing line, L, is pulled taut, the stop element, P, is retained against the outer surface of the trunk 812 at one or more of the following locations: (a) along a segment of the line L designated in FIG. 38 as L1 and abutting the first line eye 920 on the proximal side 923 of the bobber 910, (b) along a segment of the line L designated in FIG. 38 as L2 and positioned between the second and third line eyes (922, 932) on the outer surface of the top portion 912a of the trunk 912 of the bobber 910, and/or (c) along a segment of the line L designated in FIG. 38 as L3 and abutting the fourth line eye 934 on the distal side 925 of the bobber 910.

FIG. 39 shows a top-side plan view of the bobber 910, showing the indentation 940 for engagement with a stop element P, and the second and third line eyes 923, 932 for engagement with a fishing line L as discussed with similar prior figures.

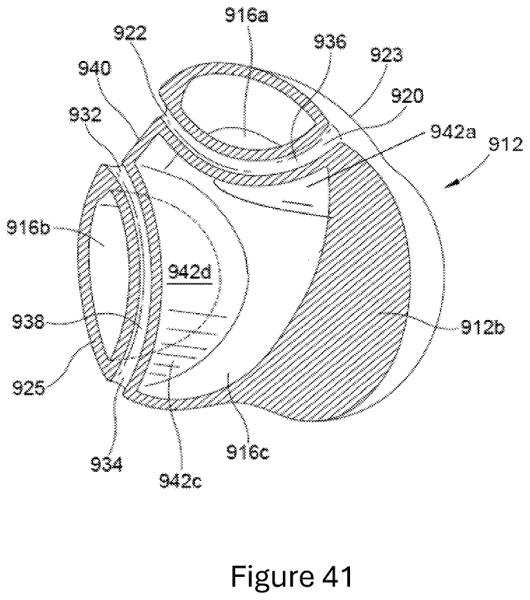

As shown in FIG. 40-FIG. 41, in some embodiments the bobber 910 includes a first internal elongated channel 936 which extends along an interior portion of the trunk 912 near the proximal side 923 of the bobber 910 to fluidly connect the first line eye 920 and the second line eye 922, creating a passage through the trunk 912 of the bobber 910 configured to receive and allow a fishing line L to slidably pass therethrough. The bobber 910 may include a second internal elongated channel 938 which extends along an interior portion of the trunk 912 near the distal side 925 of the bobber 910 to fluidly connect the third line eye 932 and fourth line eye 934, creating a passage through the bobber 910 configured to receive and allow a fishing line L to slidably pass therethrough. Though not limiting on the scope of embodiments, each internal channel (936, 938) may be formed integrally within the trunk 912 during a 3D printing or other manufacturing process. Alternatively, one or more internal channels may comprise one or more separate components (e.g., a passage formed integrally within the trunk 912 during a 3D printing or other manufacturing process but not extending to an internal surface on the right side 926 or left side 928 of the bobber 910). Also, alternatively, one or more internal channels may compromise a separate component such as a tube formed of plastic, metallic or other material that is inserted, embedded, or otherwise positioned through the trunk 912 to connect one or more line eyes (920, 922, 932 and/or 934) and allow a fishing line L to slidably pass therethrough.

It will be understood that certain structural features described previously also may be present in embodiments according to FIG. 38-FIG. 42. For example, the lower weighted portion 912b of the bobber 910 may have a center of mass (not shown) that is laterally offset from vertical yaw axis Y-Y toward the proximal side 923 of the trunk 912. Likewise, the top portion 912a may be formed as a primary bulbous portion that transitions on the proximal and distal sides (923, 925)—via smooth, continuous, asymmetric compound curvatures—into the lower weighted portion 912b which is laterally offset from vertical yaw axis Y-Y.

As shown in FIG. 40, similar to FIG. 36B, the top portion 912a may include one or more air pockets 916 to keep the top portion 912a of the bobber 910 floating above the surface S of the water when in use. The one or more air pockets may be hollow cavities (0% infill) formed during a 3D printing or other manufacturing process. FIG. 40, similar to FIG. 36B, illustrates a first air pocket 916a positioned within the top portion 912a of the trunk 912 near the proximal side 923, a second air pocket 916b positioned within the top portion 912a of the trunk 912 near the distal side 925, and a third air pocket 916c positioned above the lower weighted portion 912b of the trunk 912, extending vertically upward into the top portion 912a between the first and second internal channels (936, 938). The number of air pockets 916 and their shapes, sizes, and locations within the top portion 912a of the trunk 912 may be varied without departing from the scope of the embodiments and alternatives included herein. For example, in some embodiments, a single air pocket may be used, while in other embodiments two or more air pockets may be incorporated.

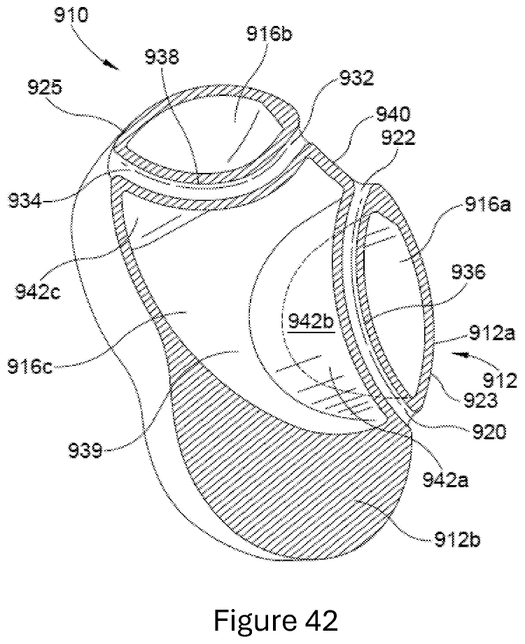

In some embodiments, the structural integrity of the individual air pockets (916a, 916b, and 913c) is supported in the interior of the trunk 912 by one or more solid partitioning walls, which in FIG. 41 and FIG. 42, respectively, are identified as 942a-942d. Accordingly, in some embodiments, partitioning walls may extend away from each channel (936, 938) on both sides until they connect with an interior surface 939 of the trunk 912, generally at or near the proximal and distal sides (923, 925) of the trunk 912, respectively. Besides supporting the channels (936, 938), the optional partitioning walls may create the three separate air pockets (916a, 916b and 916c) discussed previously. The partitioning walls 942 are optional and may be eliminated, resulting in a single continuous air pocket within the trunk 912 of the bobber 910 or at least within the top portion 912a of the bobber 910. Still further, in other embodiments (not shown), the one or more air pockets 916 may be partially infilled (i.e., less than 100% infill) with plastic or other material. In general, the one or more air pockets 916 should provide sufficient buoyancy to the bobber 910 such that, when in use, the top portion 912a (or at least a majority of it) of the trunk 912 floats above the surface S of the water and the lower weighted portion 912b sits below the surface S of the water. Optionally, the one or more pockets 916 may be partially or completely filled with one or more solid or semi-solid buoyant materials as described in the above nonlimiting examples.

Although structural features such as partitioning walls and an indentation are illustrated and discussed with respect to a particular set of figures, such as FIG. 41 and FIG. 42, it will be understood that the structural features illustrated and described with respect to FIG. 22-FIG. 45 can be used in any various combinations in any of the embodiments contemplated within this range of embodiments and illustrative figures.

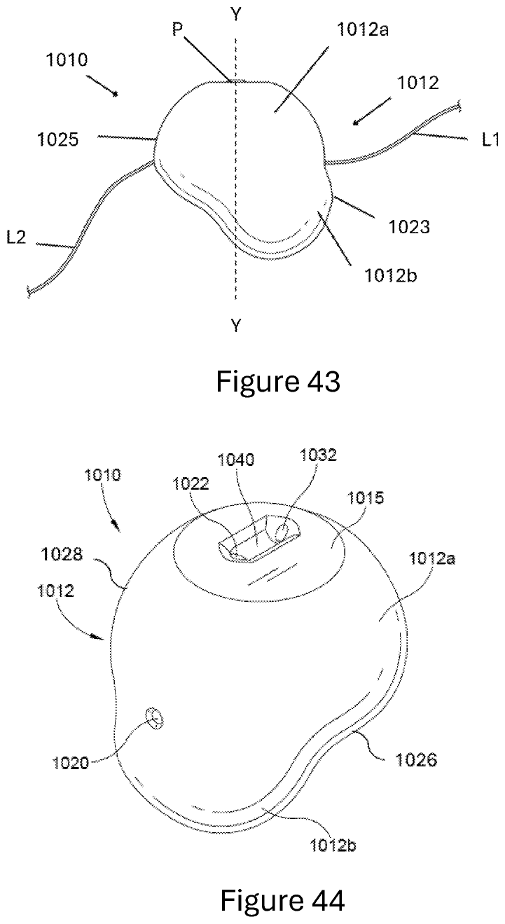

With reference to FIG. 43 and FIG. 44, wherein like reference numerals indicate like components, in some embodiments a bobber 1010 comprises a trunk 1012, having again a top portion 1012a which floats above the surface S of the water and a lower weighted portion 1012b that is designed to sit below the surface S of the water when in use. The bobber 1010 further comprises a proximal side 1023, a distal side 1025, a first lateral (or right) side 1026 and a second lateral (or left) side 1028. In a typical orientation during use, relative to the vantage point of the angler, the right side 1026 is disposed laterally to the vertical yaw axis Y-Y of the bobber 1010, and the left side 1028 is disposed laterally to the left of this axis. Again, with respect to FIG. 43 and FIG. 44, in some embodiments the bobber 1010 includes a first line eye 1020 located on the proximal side 1023 of the bobber 1010 between the top portion 1012a and the lower weighted portion 1012b of the trunk 1012, a second line eye 1022 located toward the proximal side 1023 of the bobber 1010 on or near the top surface of the top portion 1012a of the trunk 1012, a third line eye 1032 located toward the distal side 1025 of the bobber 1010 on or near the top surface of the top portion 1012a of the trunk 1012, and a fourth line eye 1034 located on the distal side 1025 of the bobber 1010 between the top portion 1012a and the lower weighted portion 1012b of the trunk 1012. As best seen in FIG. 44, in some embodiments the bobber 1010 includes an indentation 1040 positioned within the outer surface of the top portion 1012a between the second line eye 1022 and third line eye 1032 in which a stop element P attached to a fishing line L may be seated. The lower weighted portion 1012b of the bobber 1010 has a center of mass (not shown) that is laterally offset from the vertical yaw axis Y-Y toward the proximal side 1023 and is not aligned with the center of mass (also not shown) of the top portion 1012a. Another feature according to multiple embodiments and alternatives, as seen in FIG. 43 and FIG. 44, is a bobber 1010 with an outer surface of the top portion 1012a that is generally flat or planar between the second line eye 1022 and the third line eye 1032.

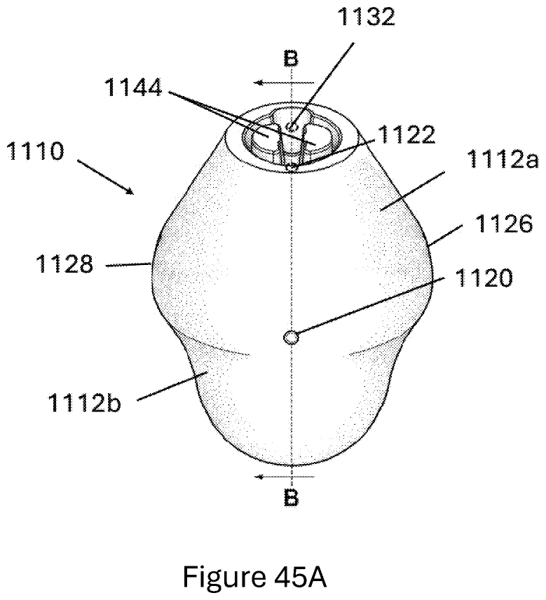

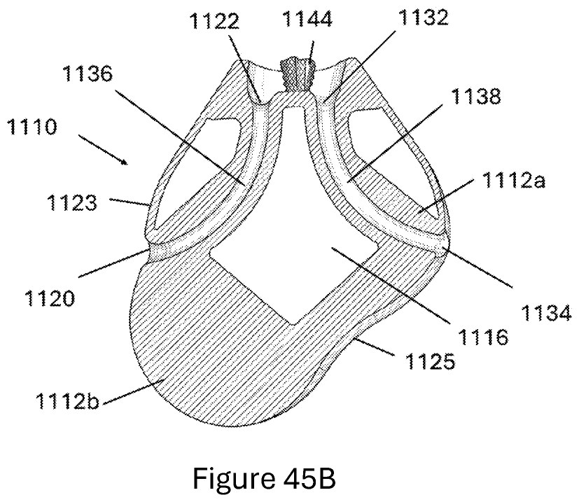

With reference to FIG. 45A and FIG. 45B, wherein like reference numerals indicate like components, in some embodiments a bobber 1110 comprises a trunk 1112, having again a top portion 1112a which floats above the surface S of the water and a lower weighted portion 1112b that is designed to sit below the surface S of the water when in use. In some embodiments, the trunk 1112 comprises an air pocket 1116, best seen in the cross-sectional view of FIG. 45B. In a non-limiting manner, FIG. 45B illustrates one air pocket, although in cross-section the air pocket 1116 appears to have three parts. The bobber 1110 further comprises a proximal side 1123 (facing the viewer in FIG. 45A), a distal side 1125 (positioned away from the viewer and not seen in FIG. 45A), a first lateral (or right) side 1126 and a second lateral (or left) side 1128. In a typical orientation during use, relative to the vantage point of the angler, the right side 1126 is disposed laterally to the vertical yaw axis Y-Y of the bobber 1110, and the left side 1128 is disposed laterally to the left of this axis. Again, with respect to FIG. 45A and FIG. 45B, in some embodiments the bobber 1110 includes a first line eye 1120 located on the proximal side 1123 of the bobber 1110 between the top portion 1112a and the lower weighted portion 1112b of the trunk 1112, a second line eye 1122 located toward the proximal side 1123 of the bobber 1110 on or near the top surface of the top portion 1112a of the trunk 1112, a third line eye 1132 located toward the distal side 1125 of the bobber 1110 on or near the top surface of the top portion 1112a of the trunk 1112, and a fourth line eye 1134 located on the distal side 1125 of the bobber 1110 between the top portion 1112a and the lower weighted portion 1112b of the trunk 1112.

With continued reference to FIGS. 45A and 45B, the bobber 1110 may include a line stop structure 1144 between the second line eye 1122 and third line eye 1132. In some embodiments, the line stop structure 1144 secures a fishing line to the fishing bobber, and it is formed integrally as part of bobber 1110, such that a stop element P (optional in some embodiments) need not be attached to the fishing line L in order to secure the hook H and/or bait B at a fixed depth beneath the surface S of the water. Rather, with such embodiment, the fishing line L may be wrapped around the line stop structure 1144, thus providing additional contact between the line L and the bobber 1110 such that the line L is fixed to the bobber 1110 in a relatively static or secure position when subjected to anticipated loads when fishing. In some embodiments, the line stop structure 1144 includes a coarse outer surface to provide additional friction between said coarse outer surface and the line L, which further tends to hold the position of the line L. The second line eye 1122 and third line eye 1132 are illustrated in phantom lines in FIG. 45A due to their location relative to the line stop structure 1144. As described with other embodiments, the lower weighted portion 1112b of the bobber 1110 as seen in FIGS. 45A and 45B has a center of mass (not shown) that is laterally offset from the vertical yaw axis Y-Y toward the proximal side 1123 and is not aligned with the center of mass (also not shown) of the top portion 1112a.

It will be understood that the embodiments described herein are not limited in their application to the details of the teachings and descriptions set forth, or as illustrated in the accompanying figures. Rather, it will be understood that the present embodiments and alternatives, in the context of terminal fishing tackle, as used herein, and particularly with respect to fishing bobbers or floats, that words, phrases and/or abbreviations used herein such as, but not to, “such as,” “comprising,” “e.g.,” “i.e.,” “containing,” or “having” and variations of the foregoing is meant to encompass the items listed thereafter, and equivalents of those, as well as additional items. The use of “including” (or, “include,” etc.) should be interpreted as “including but not limited to.” Accordingly, the foregoing descriptions of several embodiments and alternatives are meant to illustrate, rather than to serve as limits on the scope of what has been disclosed herein. It will be understood by those having ordinary skill in the art that modifications and variations of these embodiments are reasonably possible in light of the above teachings and descriptions.

1. A fishing bobber for attachment to a fishing line, comprising:
a trunk having an outer surface and an interior, wherein the trunk further comprises a proximal side, a distal side, a first lateral side, and a second lateral side;
a top portion and a bottom portion which are asymmetric relative to a horizontal plane, wherein the top portion is characterized by a buoyancy greater than a buoyancy of the bottom portion, the bottom portion characterized by a weight greater than the top portion and having a lobulated curvilinear geometric shape;
a first line eye located on the proximal side of the trunk and at least a second line eye located on the top portion of the trunk, wherein the at least two line eyes form separate openings in or along the outer surface of the trunk, wherein each line eye opening permits entry or exiting of the fishing line into, out of, or along the trunk;
wherein in operation in an aquatic environment with the fishing bobber aligned with a first axis, the trunk exhibits an unequal weight distribution laterally and vertically, from a perspective facing the first lateral side or the second lateral side of the bobber, and wherein an at least partially downward force applied to the fishing line when attached to the fishing bobber causes the trunk to rotate about a second axis which is perpendicular to the first axis.

2. The fishing bobber of claim 1, further comprising at least one hollow cavity within the interior of the trunk.

3. The fishing bobber of claim 1, further comprising a third eye and a fourth line eye.

4. The fishing bobber of claim 3, wherein the third line eye is located on the top portion of the trunk, the second line eye is located closer to the proximal side of the trunk than is the third line eye; and the fourth line eye is located on the distal side of the trunk.

5. The fishing bobber of claim 3, further comprising first and second internal passages, wherein each internal passage extends through an interior of the trunk between two line eyes.

6. The fishing bobber of claim 5, wherein at least one internal passage comprises a tube.

7. The fishing bobber of claim 5, wherein at least a portion of the outer surface of the top portion comprises a flat planar surface, wherein the flat planar surface is located between the second line eye and the third line eye, the top portion of the trunk further comprising an indentation formed as a recess within the at least partially flat planar surface, wherein the indentation is configured to receive a fishing line stop element.

8. The fishing bobber of claim 5, further comprising at least one hollow cavity within the interior of the trunk, wherein the interior of the trunk further comprises a plurality of partitioning walls joining one of the internal passages to an interior surface of the trunk, wherein at least one partitioning wall forms one side of the at least one hollow cavity.

9. The fishing bobber of claim 8, wherein at least one internal passage comprises a channel, wherein the channel is formed integrally with a surface of at least one partitioning wall.

10. The fishing bobber of claim 5, further comprising a plurality of distinct air pockets, with at least one of the air pockets positioned within the top portion of the trunk.

11. The fishing bobber of claim 1, wherein the unequal weight distribution is characterized vertically as the bottom portion of the trunk being heavier than the top portion.

12. The fishing bobber of claim 11, wherein the bottom portion of the trunk has a center of mass positioned below a vertical midpoint of the height of the trunk and laterally offset from a first axis of the trunk referred to as a vertical axis.

13. The fishing bobber of claim 3, wherein the unequal weight distribution is characterized laterally as the proximal side of the trunk being heavier than the distal side.

14. The fishing bobber of claim 3, further comprising an indentation formed on the outer surface of the top portion and located between the second line eye and the third line eye, wherein the indentation is configured to receive a fishing line stop element.

15. The fishing bobber of claim 1, further comprising a line stop structure for securing a fishing line to the fishing bobber.

16. The fishing bobber of claim 3, further comprising a line stop structure for securing a fishing line to the fishing bobber.

17. The fishing bobber of claim 16, wherein the line stop structure is located between the second line eye and the third line eye.

18. A kit comprising the fishing bobber of claim 1 and a fishing line stop element comprising a first opening and a second opening for the fishing line to pass through.

19. The kit of claim 18, wherein the fishing bobber further comprises an indentation formed on the outer surface of the fishing bobber, and wherein pulling the fishing line taut relative to the trunk causes the fishing stop element to be received into the indentation.

20. The kit of claim 18, wherein the fishing bobber further comprises at least one hollow cavity within the interior of the trunk.
